(19) United States
(12) Patent Application Publication
(10) Pub. No.: US 2022/0171443 A1
(43) Pub. Date: Jun. 2, 2022

(54) METHOD FOR FACILITATING DYNAMIC POWER DISTRIBUTION IN A MULTIPORT POWER SOURCING DEVICE

(71) Applicant: SILICONCH SYSTEM PVT LTD, Bangalore (IN)

(72) Inventors: Kaustubh KUMAR, Lucknow (IN); Rakesh Kumar POLASA, Bengaluru (IN); Munnangi SIRISHA, Guntur (IN); Siva Naga Subrahmanya Saratchandra BHAGAVATHULA, Hyderabad (IN)

(73) Assignee: SILICONCH SYSTEM PVT LTD

(21) Appl. No.: 17/463,323

(22) Filed: Aug. 31, 2021

(30) Foreign Application Priority Data
Nov. 28, 2020 (IN) 202041051935

(51) Int. Cl. G06F 1/26; H02J 7/00

(52) U.S. Cl. CPC G06F 1/26; G06F 13/382; H02J 7/0042

(57) ABSTRACT

The present disclosure relates to a method for facilitating dynamic power allocation and distribution in a multi-port power sourcing device. The method comprises receiving, by a first set of instructions to be executed on a multi-port power sourcing device, the one or more input parameters at the multi-port power sourcing device. The first set of instructions is executed at the multi-port power sourcing device. The first set of instructions pertains to power distribution and operational decision-making across each of the port of the multi-port power sourcing device. Further, a second set of instructions are executed based on the executed first set of instructions. The second set of instructions is executed to manage operations pertaining to a single port of the plurality of ports of the multi-port power sourcing device. The executed first set of instructions control the second set of instructions via a request-response communication interface.

### CROSS-REFERENCE TO RELATED APPLICATIONS

This application claims priority to India Patent Application No. 2020-41051935, filed Nov. 28, 2020, the contents of which are incorporated herein by reference in its entirety for all purposes.

### BACKGROUND

### Technical Field

The present disclosure relates to a method for dynamic allocation, up gradation, distribution and redistribution of power in a multiport power sourcing device.

### Related Art

There are many devices that require more power than certain other devices. Many bus specifications supply only a specific amount of electrical power to each port. For example, a traditional Dedicated Charging Port (DCP) over USB Type-A connector can supply a maximum of 1.5 A @ 5V (7.5 W) as per Battery Charging 1.2 (BC1.2) specification. USB Type-C specification, for USB Type-C connector and cables, further increases the maximum supply to 3 A @ 5V (15 W). Additionally, for higher power delivery over USB Type-C connector, USB Power Delivery (USB-PD) specification is defined to extend the power supply limits to 100 W and even beyond. Proprietary fast charging protocols with similar higher power supply limits exist with support for both USB Type-A as well as USB Type-C connectors.

There might be devices in the near future whose fast charging requirements and data processing services would require them to draw more power than the contemporary devices. For example, smartphones supporting fast charging with 2S Li-ion batteries may require a supply of 9V @ 5 A (45 W). The more the current drawn, the faster will be the charging of the batteries. This will ultimately be beneficial for the end user. The total power rating of a multiport power sourcing device may be lesser than the cumulative power requirement of the connected sinks to each of the ports. Further, a total power budget of a multiport power sourcing device may be utilized either by dedicating pre-determined portions of the budget to individual ports or by sharing the same total budget across all the ports. Hence, a power sourcing device which sources power across multiple ports to sink devices, must manage the power distribution efficiently, such that neither of the sink devices are deprived whereas others are consuming higher power. This leads to power sourcing device adjusting its power distribution through phases of sink discovery and power up-gradations after connection detection. Further, existing solutions do not specify a method for separating the power distribution flow from the individual port handling in a multiport power sourcing device, such that the generic power distribution flow can be applicable to any charging/power delivery protocol. Also, whenever there is a sudden connection of new devices or disconnection of existing devices, the power supply again must readjust the power distribution to withstand the increased power demand or to redistribute in case power is withdrawn from a port.

There is therefore a need in the art for a real time distribution and allocation of power in the plurality of ports in multiport power devices using a protocol agnostic centralized power distribution flow coupled to individual port handling flows.

### SUMMARY

Some of the objects of the present disclosure aimed to ameliorate one or more problems of the prior art or to at least provide a useful alternative are listed herein below.

An object of the present disclosure is to provide a method that distributes power dynamically for multiport power sourcing devices.

An object of the present disclosure is to provide a method that distributes power in a USB Type-C/Type-A based multiport power sourcing device.

An object of the present disclosure is to provide a method that distributes power for multiport power sourcing devices while additionally complying with the base rules specified by USB Type-C, USB Type-A, USB power delivery specifications and other charging protocols.

An object of the present disclosure is to provide a method that encompasses both shared capacity and assured capacity power adapters as per USB Type-C specification and specifies additional power sharing configurations.

An object of the present disclosure is to provide a method that handles detection of a device connection/disconnection, dynamic power allotment and redistribution through a sink profile detection/discovery and communication.

An object of the present disclosure is to provide a method that handles USB PD source capabilities dynamic generation focused on sink capabilities.

Another object of the present disclosure is to provide a method that facilitates to handle sink notifications for insufficient power and performing possible power up-gradation.

The present disclosure relates to a method for dynamic allocation, up gradation, distribution and redistribution of power in a multiport power sourcing device.

According to an aspect of the present disclosure, a method is provided for facilitating dynamic power allocation and distribution in a multi-port power sourcing device. The method comprises: receiving, by a first set of instructions to be executed on a multi-port power sourcing device, one or more input parameters at the multi-port power sourcing device, the one or more input parameters pertaining to a plurality of ports of the device, total power rating of the device, maximum power rating of each of a port of the plurality of ports and minimum guaranteed power to be reserved for each of the port of the plurality of ports; executing, at the multi-port power sourcing device the first set of instructions based on the input parameters, the first set of instructions pertaining to power distribution and operational decision-making across each of the port of the plurality of ports of the multi-port power sourcing device, wherein the executed first set of instructions have one instance for the multi-port power sourcing device and manage allocated power across each of the port of the plurality of ports and available power; and executing, at the multi-port power sourcing device a second set of instructions based on the executed first set of instructions, the second set of instructions being executed to manage operations pertaining to a single port of the plurality of ports of the multi-port power sourcing device, wherein the executed first set of instructions control the second set of instructions via a request-response communication interface.

According to an embodiment, each of the port of the plurality of ports of the multi-port power sourcing device is any of a Universal Serial Bus (USB) Type-C port and a USB Type-A port, and where each of the plurality of ports complies to a predefined USB power delivery specification or to a predefined proprietary charging protocol.

According to an embodiment, upon execution of the second set of instructions power is delivered to the single port over a Voltage Bus (VBUS) line of a physical USB port based on an active power negotiation protocol and on control requests received from the first set of instructions.

According to an embodiment, the first set of instructions is configured to perform power distribution across each of the port of the plurality of ports of the multi-port power sourcing device using at least one of an Individual-Dedicated-Reserve (IDR) power distribution mechanism, a Common-Combined-Reserve (CCR) power distribution mechanism or a Hybrid-Reserve (HR) power distribution mechanism.

According to an embodiment, when the power distribution is performed using the IDR power distribution mechanism, the sum of power rating of individual ports of the plurality of ports is equal to the total power rating of the multi-port power sourcing device and each of the port of the plurality of ports is allocated a dedicated power rating, and wherein the second of instructions manage a dedicated power reserve with or without communicating with the first set of instructions.

According to an embodiment, when the power distribution is performed using the CCR power distribution mechanism, the sum of power rating of individual ports of the plurality of ports is greater than the total power rating of the multi-port power-sourcing device and the first set of instructions allocate power from a specified common power reserve such that power allocation to a port is upgraded in incremental steps based on sink power requirements.

According to an embodiment, the first set of instructions are executed to perform power distribution across the plurality of ports using any of the IDR power distribution mechanism or the CCR power distribution mechanism, and wherein the first set of instructions controls the power allocation to each of the port such that the allocated power neither exceeds individual power rating of the port nor the total power rating of the multi-port power-sourcing device.

According to an embodiment, when the multi-port power sourcing device is powered on and the device uses the CCR power distribution mechanism, the first set of instructions executed on the multi-port power sourcing device activates each of the second set of instructions associated with each of the ports, and wherein the first set of instructions are configured to inform each of the second set of instructions about a minimum level of power to be reserved and allocated on each of unconnected port of the plurality of ports.

According to an embodiment, the reserved minimum level of power to be allocated is configurable, and is allocated dynamically on a USB Type-C connection configuration channel (CC) line detection, and wherein the second set of instructions are executed to supply the minimum allocated power over VBUS at a sink connection detection event when the initial allocated power is greater than or equal to 7.5 W for Type-A connection and 15 W for Type-C connection.

According to an embodiment, in case the minimum allocated power for a port with a new USB Type-C sink connection is less than 15 W due to power unavailability, the second set of instructions are executed to wait for a power allocation of greater than or equal to 15 W from the first set of instructions to start supplying VBUS power, and wherein the first set of instructions during the wait time deallocates the required amount of power from the plurality of ports in a balanced or priority manner.

According to an embodiment, in case the minimum allocated power for a port with a new USB Type-C sink connection is less than 15 W due to power unavailability, for a USB-PD protocol, the first set of instructions immediately force a give back capable sink connected to any of the other ports by instructing the second set of instructions to send a GotoMin message to retrieve the give back power and provide the initial minimum power required for the new sink connection, wherein the second set of instructions decode the give back power, if advertised in the request message sent by a sink connected to any of the other ports, and inform the first set of instructions.

According to an embodiment, when the power distribution is performed using the CCR power distribution mechanism, the second set of instructions, after detecting a sink device connection, discover support of a higher power negotiation protocol and upon discovering the support, the second set of instructions advertise different voltage profiles and corresponding current limits adhering to the power allocated to the port by the first set of instructions, and where the different voltage profiles are custom configured or are based on a set of profiles dependent on the higher power negotiation protocol.

According to an embodiment, for an upgrade in the higher power negotiation protocol, the second set of instructions are executed to discover a sink support of the USB Power Delivery (USB-PD) protocol by sending a first data packet on a CC line and awaiting a time bounded detection of the second data packet from a sink across a set number of retry attempts, and wherein the second set of instructions uses the first data packet to advertise custom-configured or normative power profiles that are configured based on supply type and supply voltage, and wherein the current limits advertised corresponding to each power profile are dynamically set by the second set of instructions to adhere to the power allocated to the port by the first set of instructions.

According to an embodiment, for an upgrade in the higher power negotiation protocol, the second set of instructions are executed to discover sufficiency of an allocated power according to an established power negotiation protocol and an alert signal is sent to the first set of instructions related to success or failure of establishment of the higher power negotiation protocol, wherein the alert signal further comprises information related to sufficiency of allocated power to meet sink power requirements.

According to an embodiment, the first set of instructions are executed to instruct the second set of instructions to discover or detect higher sink power requirements, and where the second set of instructions inform about the discovered or detected higher sink power requirements to the first set of instructions by following a sink profile discovery mechanism, and where the first set of instructions are executed to upgrade the power allocated to the single port, in a conservative manner, to minimum of three of power detected or power discovered by the second set of instructions, available power in the common power reserve, and the port power rating.

According to an embodiment, the sink profile discovery or detection is done by the second set of instructions only once initially until disconnection of the sink device, and wherein the discovered sink profiles are preserved by the second set of instructions, and are requested by the first set of instructions when needed.

According to an embodiment, in another configuration, the first set of instructions are executed to periodically request the second set of instructions to discover and detect the sink profiles.

According to an embodiment, the first set of instructions are additionally executed to request the second set of instructions to discover and detect the sink profiles whenever a power allocation change happens to any of the other port of the plurality of ports.

According to an embodiment, the power allocated to the single port is configurable, and the power is allocated in a no-priority balanced manner, or priority-based manner to the single port, where the priority based manner is based on any of a random order, a round-robin order, a connection order, and an increasing order of the allocated power.

According to an embodiment, one or more port groupings are provided for the IDR power distribution mechanism or the CCR power distribution mechanism, and wherein each of the port of the plurality of ports has the individual power rating that is either similar or is varying within a port grouping of the one or more port groupings.

According to an embodiment, for the CCR power distribution mechanism, a maximum individual port power rating for a port is equal to the total power rating of the multi-port power sourcing device.

According to an embodiment, for performing a power upgrade in the CCR power distribution mechanism, the second set of instructions inform the first set of instructions of a next higher power and a highest power required by the sink, wherein the first set of instructions perform multiple rounds of retrievals of next higher power and corresponding allocated power upgrades, wherein the first set of instructions directly upgrade the allocated power to the highest power level required by the sink, if the power is available and if configured to do so, either after a maximum configurable rounds of allocated power upgrades or after a particular timeout from the time of sink connection detection.

According to an embodiment, for the USB-PD protocol the second set of instructions decode the next higher power by comparing an operational current value from a third data packet with a maximum current supported by the USB Type-C cable, and wherein a lesser value of the operational current value and the maximum cable current is used to determine a power requirement, the determined power requirement being informed about to the first set of instructions.

According to an embodiment, for the USB-PD protocol, the voltage levels and the supply types mentioned by sink in the third data packet are used by the second set of instructions directly in advertising the next set of capabilities in the first data packet, wherein the maximum current offered for each voltage profile is tuned as per the power allocated to the port by the first set of instructions.

According to an embodiment, for the USB-PD protocol, for a fixed supply sink requirement, the second set of instructions advertise a fixed supply PDO and divide the power allocated to the port by the fixed supply voltage level to facilitate generation of a value of the maximum current field in the first data packet fixed supply PDO.

According to an embodiment, for the USB-PD protocol, the first data packet is generated upon execution of the second set of instructions, wherein for a programmable power supply (PPS) sink requirement, if the second set of instructions is configured to operate in a constant power mode apart from a constant voltage and constant current modes, the second set of instructions advertise a PPS augmented power data object (APDO) and divide the power allocated to the port by a nominal voltage corresponding to maximum and minimum voltage, to facilitate generation of value of maximum current field in the first data packet PPS supply APDO, and the second set of instructions sets the power limited to ‘1’ in the first data packet PPS supply APDO.

According to an embodiment, if the second set of instructions is configured to not support a constant power mode, the second set of instructions divide the power allocated to the port by a maximum voltage level to generate a value of a maximum current field in the first data packet PPS supply APDO, wherein the second set of instructions set power limited to ‘0’ during the first data packet PPS supply APDO.

According to an embodiment, for the USB-PD protocol, for a variable supply sink requirement, the second set of instructions advertise a variable supply PDO, wherein the maximum and minimum voltage in the variable supply PDO are set based on the regulation range of the power supply, and wherein the power allocated to the port is divided by the maximum voltage level to facilitate generation of the value of the maximum current field in the first data packet variable supply PDO.

According to an embodiment, for the USB-PD protocol, for all supply types, the maximum current value generated by the second set of instructions is limited to the maximum current supported by the cable.

According to an embodiment, the first set of instructions maintain a first flag for each of the port of the plurality of ports, wherein the first flag set to 1 for a port is an indication of insufficient power allocated to the port, and wherein for the USB-PD protocol, the first flag value is deduced by the second set of instructions directly or indirectly from a CapabilityMismatch bit in a Request Data Object (RDO) of the Request message sent by the sink.

According to an embodiment, the first flag for a port is cleared by the first set of instructions on occurrence of any of an event related to a power upgrade by the first set of instructions to meet the power requirements of the sink on the port, reduction of sink power requirement informed by the sink or detected by the second set of instructions on the port, and a sink disconnection event on the port.

According to an embodiment, for the USB-PD protocol, the first set of instructions clear the first flag value associated with a port in case when the sink sends a Request message with CapabilityMismatch bit cleared, either with or without any allocated power upgrade done by the first set of instructions.

According to an embodiment, the first set of instructions clear the first flag value associated with a port when the power allocation to the port cannot be upgraded by the first set of instructions as the already allocated power is equal to the power rating of the port.

According to an embodiment, the first set of instructions mask the first flag value associated with a port on occurrence of at least no possible power upgrade due to zero available power or the current requirement of the sink exceeding the current rating of the port or the current rating of the cable.

According to an embodiment, the first set of instructions unmasks the first flag values for all the ports on a new power allocation to or a sink disconnection on any of the ports of the plurality of ports.

According to an embodiment, the first set of instructions reduce allocated power to a port in case the sink connected reduces its power requirements or the sink gets disconnected, and wherein the reduced allocated power is dynamically allocated to the other needy ports, based on either a balanced or a priority mechanism, wherein the reduction of allocated power requirement of the sink may be notified by the sink itself or is detected and discovered by the second set of instructions.

According to an embodiment, when the power distribution is performed using a HR power distribution mechanism, the first set of instructions are executed to perform the power distribution across the plurality of ports using any of the IDR mechanism or the CCR power distribution mechanism.

According to an embodiment, for the HR power distribution, the first set of instructions manage either separate dedicated power reserves across the IDR and CCR groups of ports, or a total power reserve across the IDR and CCR groups of ports, wherein, for the total power reserve, the power on CCR groups of ports is allocated as per total power rating of the multi-port power sourcing device, as long as all of the IDR ports remain unconnected, and wherein, upon an IDR port getting connected, power equal to the rating of the IDR port is allocated by the first set of instructions to the port from an available power reserve, else the allocated power on the connected CCR port is reduced in a balanced manner or a priority-based order.

Various objects, features, aspects and advantages of the present disclosure will become more apparent from the following detailed description of preferred embodiments, along with the accompanying drawing figures in which like numerals represent like features.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A to 1D illustrate an exemplary representation of a first set of instructions, for managing centralized and protocol agnostic distribution of power in a multiport power sourcing device in accordance with an embodiment of the present disclosure.

FIGS. 2A to 2D illustrate an exemplary representation of a second set of instructions, for performing operations pertaining to actual supply of power over a single port of the power sourcing device in accordance with an embodiment of the present disclosure.

FIGS. 3A to 3C illustrate an exemplary representation of a POWER_ALLOCATION sub-routine of the MCA, for dynamic allocation of power to a port index p in a multiport power sourcing device in accordance with an embodiment of the present disclosure.

FIGS. 4A and 4B illustrate an exemplary representation of a POWER_DEALLOCATION sub-routine of the MCA for dynamic de-allocation of power in a multiport power sourcing device in accordance with an embodiment of the present disclosure.

FIG. 5 illustrates an exemplary representation of a GET_PORT_IDX_FOR_SERVICE sub-routine of the MCA for retrieving the next port index to service for power upgradation in a multiport power sourcing device in accordance with an embodiment of the present disclosure.

FIG. 6 illustrates an exemplary representation of an INIT_DISCOVERY_PWR_PROTOCOL subroutine of the SHA for USB PD protocol discovery on initial connection detection of a sink device in accordance with an embodiment of the present disclosure.

FIG. 7 illustrates an exemplary representation of an ADV_CHG_VBUS_PWR subroutine of the SHA to advertise the SourceCapabilities advertisement in case USB PD is active on the port in accordance with an embodiment of the present disclosure.

FIG. 8 illustrates an exemplary representation of a POPULATE_SOURCE_CAP_PDOs subroutine of the SHA, in case USB PD is active on the port, in accordance with an embodiment of the present disclosure.

FIG. 9 illustrates an exemplary representation of a CHK_SNK_REQ subroutine of the SHA to validate power request from a sink device, in case USB PD is active on the port, in accordance with an embodiment of the present disclosure.

FIG. 10 illustrates an exemplary representation of a TRANS_VBUS subroutine of the SHA, in case USB PD is active on the port, in accordance with an embodiment of the present disclosure.

FIG. 11 illustrates an exemplary representation of SNK_PROF_DET subroutine of the SHA, in case USB PD is active on the port, in accordance with an embodiment of the present disclosure.

FIG. 12 is a high-level flow diagram illustrating steps for distribution of power in a multiport power sourcing device in accordance with an embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

The present disclosure relates to a method for dynamic allocation, up gradation, distribution and redistribution of power in a multiport power sourcing device.

In an embodiment, is provided a method for facilitating dynamic power distribution over USB Type-C/Type-A ports of a multi-port power sourcing device. The number of ports may be not limited for all practical requirements. Each port of the number of ports may be of USB Type-C or USB Type-A. Power distribution across each port of the number of ports may be controlled by a coordinated pair of a first set of instructions (e.g., a master control mechanism, also referred to herein as a master control algorithm or MCA) and a second set of instructions (e.g., a slave handler mechanism, also referred to herein as a slave handler algorithm or SHA).

In an embodiment, each of USB Type-C port may support various power delivery/fast charging protocols that also includes USB Type-C power delivery protocol.

Further, each of USB Type-A port may support various fast charging protocols apart from minimally providing a battery charging 1.2 (BC 1.2) dedicated charging port (DCP) functionality and power.

The disclosure provides a method for managing power distribution across each port of the number of ports of the multi-port power sourcing device.

In an embodiment, the MCA may be protocol agnostic and may have one instance, and the SHA may have one instance per port. The MCA may maintain a record of the allocated power across various ports and available power, and may control the SHAs via a request-response communication interface. In this case, the SHA may deliver power over VBUS line of physical USB port based on active power negotiation protocol out of the supported protocols and based on the control requests from the MCA.

In an embodiment, the multi-port power sourcing device may support multiple power negotiation protocols over a port (for example, USB-PD, QuickCharge, etc.), but based on the sink connected, at an instant, one protocol may be active for delivering power.

In an embodiment, the disclosed method for power distribution may facilitate configuring the MCA to perform power distribution across ports in multiple manners, such as in an Individual-Dedicated-Reserve (IDR) manner, a Common-Combined-Reserve (CCR) manner or a hybrid of the two, Hybrid-Reserve (HR) manner. Various system configurations as provided using the multiple manners are discussed in detailed below.

In the IDR power distribution manner, a sum of power rating of individual ports may be equal to power rating of the multi-port power sourcing device and each of the port may be allocated with a dedicated power rating. The SHA may in a stand-alone manner manage the dedicated power reserve and does not require communication with the MCA. Further, actual hardware/software communication interface to the MCA or other ports may or may not be physically present.

In the CCR power distribution manner, sum of power rating of the individual ports may be greater than the total rating of the multi-port power sourcing device and the MCA may allocate the port power from a specified common power reserve in a soft-start manner. This means that the power allocation to a port may be upgraded, in incremental steps, by the MCA based on sink power requirements. The MCA may also be configured to perform power distribution across some of the ports in the IDR manner and the rest of them in the CCR manner. In any of the system configurations as discussed above, the MCA may control the power allocated to each of the SHA (or the port) so as to exceed neither individual power rating of the port nor total power rating of the power-sourcing device.

In the HR power distribution, a set of ports on the multi-port power sourcing device may be designated to work in the IDR manner, and the remaining set of ports may be designated to work in the CCR manner.

In an embodiment, in port groupings for the IDR power distribution manner or the CCR power distribution manner, individual port power ratings from product specification point of view, may or may not be same in that group. Further, in the CCR power distribution manner, the maximum individual port power rating may be equal to rating of the multi-port power sourcing device.

In an embodiment, in the CCR power distribution manner, the MCA may wake up all the SHAs of individual ports at a time of power-on of the multi-port power sourcing device. The MCA may be by default configured to reserve and inform the SHAs initially a minimum level of power on every unconnected port. In an implementation, the minimum level of power may be used by the SHA for an initial 5V supply on Voltage Bus (VBUS) line, and where the minimum level of power, as per USB-IF regulations, may be 7.5 W (5V@1.5 A) for the USB Type-C ports (using Rp1.5 A advertisement on CC line) and same 7.5 W (5V@1.5 A) for USB Type-A DCP ports (using D+ and D− short). In case of the USB Type-C ports, the MCA may upgrade power to 15 W (5V@3 A) by retrieving power from other ports, as a consequence of which the SHA may change CC termination to Rp3.0, in order to advertise 3 A support by sink.

In an embodiment, for enabling the minimum level of power allocation as in the CCR power distribution, the MCA may also be custom-configured to not reserve any minimum power for USB Type-C ports. The MCA may dynamically allocate a minimum power level on a USB Type-C connection CC line detection, in which case the minimum power level may be allocated before raising the VBUS to 5V after connection detection, and the MCA may guarantee availability of the minimum power level dynamically by either retrieving required amount of power from one of the plurality of the ports connected to a give back capable sink or by deallocating required amount of power from the plurality of the ports. In an embodiment, in the CCR power distribution manner as discussed above, after the initial minimum power level allotment, the SHA may attempt to discover and/or advertise support of a higher power negotiation protocol and if supported and possible, the SHA may advertise different voltage profiles and corresponding current limits that adhere to the power allocated to that port by the MCA. Further, the different voltage profiles may be custom-configured or may be a set of normative/mandatory profiles according to the charging protocol.

In an embodiment, the higher power negotiation protocol may be upgraded. Here, in case of USB Type-C, the SHA may attempt to discover sink support of USB Power Delivery (USB-PD) protocol, by sending a first data packet (e.g., SourceCapabilities) message on a configuration channel (CC) line and may await time-bounded detection of the second data packet (e.g., GoodCRC) acknowledgement from the sink across a set number of retry attempts. Also, the SHA may use e.g., SourceCapabilities to advertise power profiles which may be custom-configured to any supply type and supply voltages. In case supply types and voltages are not custom-configured, the SHA may form a set of maximum supported number of normative voltages for Fixed and Programmable Power Supply (PPS) supply levels. In both the cases of custom-configuration and the normative advertisement, the current limits advertised corresponding to each power profile may be dynamically chosen to adhere to the power allocated to the port by the MCA.

In an embodiment, during the higher power negotiation protocol upgrade, the SHA may further attempt to discover sufficiency of initial allocated power according to the established power negotiation protocol and may alert the MCA of success/failure to establish a higher power negotiation protocol and determine whether the initial allocated power may be sufficient to meet sink power requirements.

In an embodiment, for detection of sufficiency of the initial allocated power while using USB-PD protocol, the SHA may check the Request message from the sink where the CapabilityMismatch may be set to 1 by sink to indicate that the allocated power may not be sufficient for sink power requirements and vice-versa. The SHA may then, on successful USB-PD protocol establishment, alert the MCA of the power level of the present contract and CapabilityMismatch value from Request message. Further, the same method for detection of allocated power sufficiency may be applicable to further power negotiations within the domain of USB-PD protocol.

In an embodiment, Method of CCR power distribution mentioned in claim 3, where MCA instructs SHA to perform discovery/detection of higher sink power requirements if needed, and accordingly where SHA informs higher sink power requirements to MCA by following the sink profile discovery/detection process, and where MCA upgrades power allocated to a port, in a conservative manner, to the minimum of the three of power required by sink informed by SHA, available power in the common power reserve, and port power rating, where the sink profile discovery/detection process is done only once initially and the sink profiles thus discovered/detected are preserved by the SHA, and can be requested by the MCA when needed.

In an embodiment, for performing the sink profile discovery/detection in another configuration, the MCA may be configured to periodically request the SHA to discover/detect sink profiles to account for dynamic changes in the sink requirements. In another configuration, the MCA may also be additionally configured to request the SHA to discover/detect sink profiles whenever a power allocation change happens to any of the ports.

In an implementation, the sink profile discovery/detection may be performed by the MCA by maintaining a table of Boolean values. For each of an entity of the table corresponding to a sink connected on a port, a first flag (e.g., SinkReqNotMet value) may be set to 1 for a port. This is an indication of insufficient power allocated to the port. In case of USB-PD protocol, SinkReqNotMet value may be deduced directly/indirectly from the CapabilityMismatch bit in a Request Data Object (RDO) of the Request message sent by the sink.

In yet another implementation, the sink profile discovery/detection may be performed in case of a USB-PD protocol. Here, the MCA may instruct the SHA to retrieve sink power profiles in case the SinkReqNotMet value for that particular port is set to 1, where the SHA may send GetSinkCapabilities message to the sink, retrieve the higher power numbers above already allocated power from a third data packet (e.g., SinkCapabilities response message) from the sink and inform the MCA of the next higher power and the highest power requirements of the sink. Accordingly, the MCA may upgrade the power of the corresponding port to the minimum of next higher power, available power and port power rating.

In an embodiment, after the discovery/detection of the sink profile, a power upgrade may be performed for the port. The order in which the power may be upgraded by the MCA to one or more needy ports may be configurable to be in a no-priority balanced fashion, or priority-based fashion. In the balanced fashion, the MCA may request the SHAs of all the needy ports to discover/detect the sink profiles and allocate the power to individual SHAs based on collective decision from the sink profiles from all the SHAs. Further, in the priority-based fashion, the MCA may be configured to choose an order of servicing the needy ports based on a random order selection, round-robin order, connection order or increasing order of power requirements retrieved from sink profiles.

In an embodiment, balanced power upgrade in the CCR power distribution mechanism is performed by allocating power to the needy ports. This is decided by the MCA on a weighted power requirement ratio basis. As an example, assume PADAPTER as the total power of the CCR power reserve, and P1, P2, P3 . . . Pn as the higher power requirements of the sinks connected to each port, where n is the number of ports in the CCR port group of the multi-port power sourcing device. Further, assuming weighted power requirement ratio of each port, λi=Pi/(P1+P2+P3+ . . . +Pn), and PREQ is minimum of PADAPTER and (P1+P2+P3+ . . . +Pn). The MCA may allocate the power to each port as PREQ*λ1, PREQ*λ2, PREQ*λ3, . . . PREQ*λn.

In another implementation, during the balanced power upgrade in the CCR power distribution, the MCA performs balanced power allocation to m connected ports of the multi-power sourcing device having a total of n CCR ports, where m<n. Assume PADAPTER as the total power of the CCR power reserve, P1, P2, P3 . . . . Pm are the higher power requirements of the m sinks connected to each port in the CCR port group, and Pmin1, Pmin2, . . . Pmin m−n are the minimum power requirements of the unconnected m−n CCR ports. Also assume weighted power requirement ratio of each connected port, λi=Pi/(P1+P2+P3+ . . . +Pm), the sum of minimum power requirements on unconnected ports as Pmin=Pmin1+Pmin2++Pmin m−n, and PREQ is minimum of PADAPTER-Pmin and (P1+P2+P3+ . . . +Pm). The MCA may allocate the power to each port as PREQ*λ1, PREQ*λ2, PREQ*λ3, PREQ*λn.

In yet another implementation, the balanced power upgrade in the CCR power distribution mentioned in the allocated power to the needy ports is ordered by the MCA based on a random number output from a pseudo or true random-number generator, implemented in hardware/software. Output of a random number generator may be one of the port numbers out of all the ports in the multi-port power sourcing device, where the random number generator may be configured to behave in a cyclic fashion, that is, the same port number may not be repeated until all the port numbers have been generated. The random number generator may also be configured with the space of randomness, where only the needy ports may be mentioned by the MCA to be selected by the random number generator.

In an implementation, for performing the power upgrade in the CCR power distribution, the SHA may inform the MCA of the next higher power and the highest power required by the sink. The MCA may use multiple rounds of retrievals of next higher power and corresponding allocated power upgrades, in case the sink reports requirement of higher power levels and the MCA has available power for subsequent upgrades, thus deploying soft-start mechanism. Further, where the MCA directly upgrades allocated power to the highest power level required by the sink, and if the power is available and if configured to do so, either after maximum configurable rounds of allocated power upgrades or after a particular timeout from the time of sink connection detection.

In yet another implementation, the power upgrade in the CCR power distribution is performed where, in case of the USB-PD protocol, the SHA may use the SinkCapabilities message to decode the next higher power and the highest power required by sink. The SHA may find the product of Voltage and Operational Current fields in a Fixed Supply Sink PDO to get the power requirement of a Fixed Supply based sink requirement. Further, the SHA may find the product of Maximum Voltage and Maximum Current fields in a Programmable Power Supply (PPS) Sink augmented power data object (APDO) to get the power requirement of a PPS Supply based sink requirement.

In an embodiment, for decoding higher power requirements in the CCR power distribution in case of the USB-PD protocol the SHA may compare the Operational/Max Current values from the SinkCapabilities with the maximum current supported by the USB Type-C cable and may use the lesser of the two to get the power requirement to be informed to the MCA. The SHA may retrieve the maximum current supported by cable using detection of E-Marker (electronic marker chip) in the USB Type-C cable and a corresponding DiscoverIdentity message request, whose response from the cable may contain the maximum current supported by the cable.

In an embodiment, for performing a power upgrade in the CCR power distribution in case of the USB-PD protocol, the voltage levels and supply types mentioned by the sink in SinkCapabilities message may be used by the SHA directly in advertising the next set of SourceCapabilities, where the maximum current offered for each voltage profile may be tuned as per the power allocated to the port by the MCA.

In another embodiment, the USB-PD SourceCapabilities generation in the SHA for a Fixed Supply sink requirement may be performed, where the SHA may advertise a Fixed Supply PDO and may divide the power allocated to the port by the Fixed Supply Voltage level to generate the value of Maximum Current field in the SourceCapabilities Fixed Supply PDO.

In yet another embodiment, a method for USB-PD SourceCapabilities generation in the SHA requires for a PPS Supply sink requirement. If the SHA is configured to operate in Constant Power mode apart from Constant Voltage and Constant Current modes, the SHA may advertise a PPS APDO and may divide the power allocated to the port by the nominal voltage corresponding to the Maximum and Minimum Voltage, to generate the value of Maximum Current field in the SourceCapabilities PPS Supply APDO. Accordingly, the SHA may set the Power Limited to 1 in the SourceCapabilities PPS Supply APDO.

In another embodiment, if the SHA is configured to not support Constant Power mode, the SHA may divide the power allocated to the port by the Maximum Voltage level to generate the value of Maximum Current field in the SourceCapabilities PPS Supply APDO. Accordingly, the SHA may set the Power Limited to 0 in the SourceCapabilities PPS Supply APDO.

In an embodiment, for the USB-PD SourceCapabilities generation in the SHA for a Variable Supply sink requirement, the SHA may advertise Variable Supply PDO in SourceCapabilities, and set the Maximum and Minimum Voltage based on the regulation range of the power supply. The SHA may divide the power allocated to the port by the Maximum Voltage level to generate the value of Maximum Current field in the SourceCapabilities Variable Supply PDO.

In an embodiment, for USB-PD SourceCapabilities generation in the SHA for all supply types, the maximum current generated by the SHA may be limited to the maximum current supported by the cable. Further, in an embodiment, for per-port SinkReqNotMet management, the SinkReqNotMet bit for a port may be cleared by the MCA on events such as, power upgrade by the MCA to meet the power requirements of the sink on the port. Reduction of the sink power requirement may be informed by the sink or may be detected by the source SHA on the port related to a sink disconnection event on the port.

In an embodiment, for per-port SinkReqNotMet management for the USB-PD protocol, the MCA may clear the SinkReqNotMet value associated with a port in case when the sink sends a Request message with CapabilityMismatch bit cleared, either with or without any allocated power upgrade done by the MCA.

In an embodiment, for per-port SinkReqNotMet management in case of the USB-PD protocol, the MCA may clear the SinkReqNotMet value associated with a port when power allocation to the port cannot be upgraded by the MCA as the already allocated power may be equal to the power rating of the port. In yet another embodiment, for per-port capability mismatch management, the MCA may temporarily mask the SinkReqNotMet value associated with a port for one of the following events: (a) power allocation to the port cannot be upgraded by the MCA as the available power is zero, (b) the SHA may detect that the current requirement of the sink connected to port may exceed either the current rating of the port or the current rating of the cable or both, and (c) for the USB-PD protocol, the sink may send a Request message requesting lesser power than the already allocated/advertised power, thus avoiding falsely triggered setting of SinkReqNotMet bit.

In an embodiment, for the CCR power distribution, the MCA may reduce the allocated power to a port in case the sink connected reduces its power requirements, and where the taken back power by the MCA may be dynamically allocated to the other needy ports, based on either balanced or priority method. The reduction of power requirement of the sink may be notified by the sink itself or detected/discovered by the SHA.

In an embodiment, for the CCR power distribution, the SHA of a particular port may inform the MCA of a sink disconnection, and where the MCA may revert the power allocated to that port to the minimum reserved power. Further, the taken back power by the MCA may be dynamically allocated to the other needy ports, and redistributed in a balanced or priority order.

In an embodiment, for IDR power distribution, the MCA may allocate at power-on initially, the power to the SHA associated with a port equal to the power rating of the corresponding port. The SHA may advertise different voltage profiles and corresponding current limits adhering to the power allocated to that port. The different voltage profiles may then be custom-configured or a set of normative profiles according to the charging protocol.

In an embodiment, for the HR power distribution mechanism, in one configuration, the MCA may be configured to independently handle a power reserve PCCR as CCR power reserve over a set of ports, and independently handle another power reserve PIDR as IDR power reserve over another set of ports, such that PCCR+PIDR is the total power rating of the multi-port power sourcing device. Independent handling of the CCR and the IDR power reserves may follow the above mentioned rules.

In an embodiment, for example, when out of total n ports of the multi-port power sourcing device rated at PADAPTER, m ports are specified to work in IDR fashion with a power rating of PIDR1, PIDR2, . . . PIDRm, and (n−m) ports are specified to work in CCR fashion with a maximum power rating of PCCR1, PCCR2, . . . , PCCR(n−m). Accordingly, following equations/in-equations satisfy,

PCCR0+PCCR1+ . . . +PCCR(n−m)≥PCCR

PIDR0+PIDR1+ . . . +PIDRm=PIDR

PCCR+PIDR=PADAPTER

In an embodiment, in case of the HR power distribution mechanism, in another configuration, the MCA may be configured to handle, in an on-demand manner, a total power reserve PADAPTER in the CCR fashion over a set of ports and the IDR fashion over another set of ports. The IDR power rating of each port associated with the IDR distribution may be specified, and the maximum CCR power rating of each port associated with the CCR distribution may be specified. In correspondence to this, the following equations/inequations may satisfy,

PIDR0+PIDR1+ . . . +PIDRm=PIDR

PCCR≤PADAPTER

PIDR<PADAPTER

In an embodiment, for on-demand control of the HR power distribution mechanism, the power on the CCR ports may be allocated as per total power rating of the multi-port power sourcing device, as long as all of the IDR ports remain unconnected. As soon as an IDR port gets connected, power equal to the rating of the IDR port may be allocated by the MCA to the port. Power allocated by the MCA to the connected IDR port may be taken by the MCA from available power reserve, if possible, or otherwise, from reducing the allocated power on the connected CCR ports, in a balanced manner or a priority-based order.

Referring to the drawings, the invention will now be described in more detail.

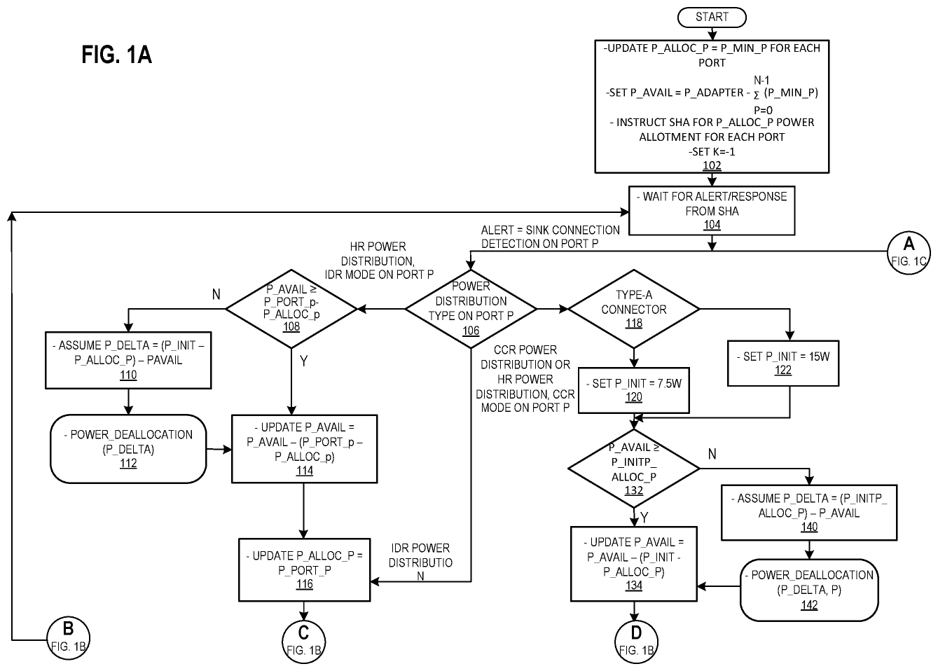

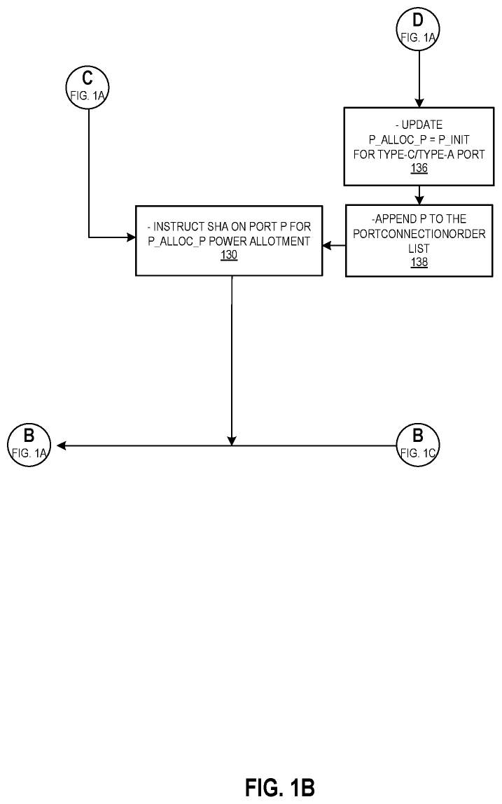

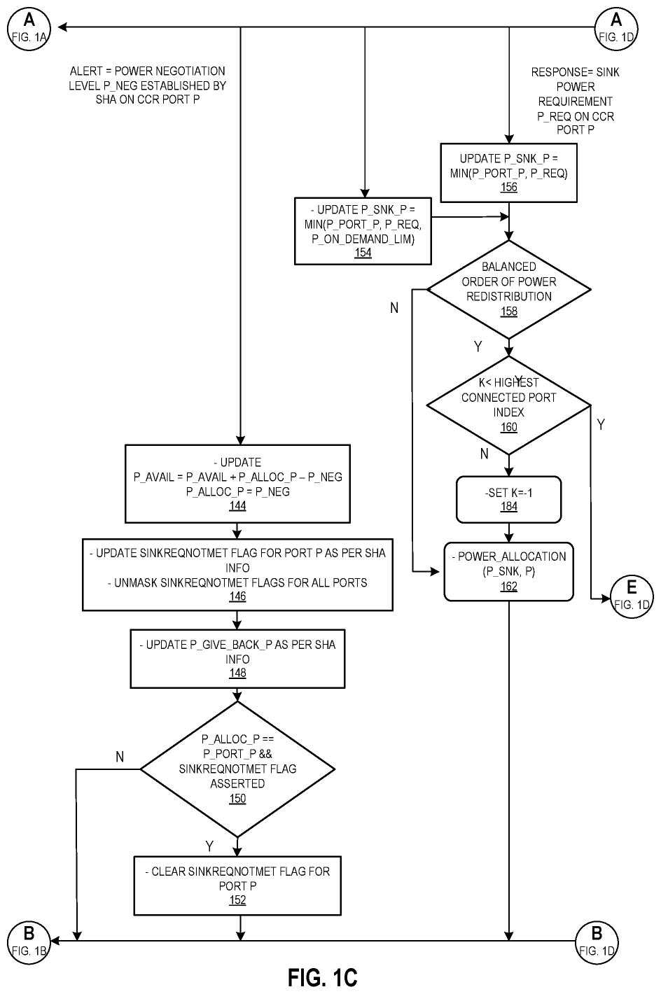

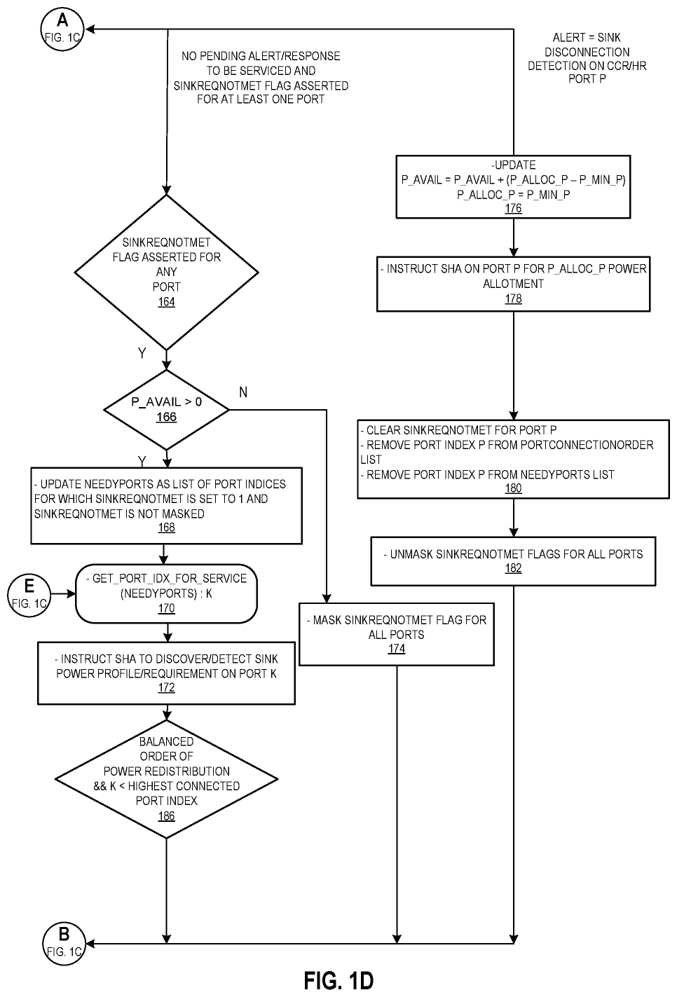

FIGS. 1A to 1D illustrate an exemplary representation of a first set of instructions for managing centralized and protocol agnostic distribution of power in a multiport power sourcing device in accordance with an embodiment of the present disclosure.

In an embodiment, with respect to FIGS. 1A to 1D, initialization of the first set of instructions is executed, at block 102, at the power on of the power sourcing device, where initial power is allocated to all n ports of the power sourcing device. At block 102, power allocated to a port p (referred to as P_ALLOC_p) is assigned as the minimum power rating of the port (referred to as P_MIN_p), which is configurable. Assuming P_ADAPTER as the total rating of the power sourcing device, the available power (referred to as P_AVAIL), after allocation of minimum power to each port, is assigned as P_AVAIL=P_ADAPTER−Σₚ₌₁ⁿP_MIN_p. The first set of instructions inform the second set of instructions for each port, about the allocated power P_ALLOC_p. An integer k is initialized to value −1. Post initialization, the first set of instructions store and update the allocated power for each port, P_ALLOC_p and the net available power, P_AVAIL.

At block 104, the first set of instructions wait for an alert indication or a response to a previous request, from the second set of instructions. The first set of instructions are executed according to the type of the alert or the response.

At block 106, the first set of instructions execute for a sink connection detection alert on a port. Assuming sink connection detection alert corresponds to port p, the first set of instructions evaluate the configuration of power distribution type for the power sourcing device on port p.

In the first case of IDR power distribution configuration, at block 116, the allocated power to the port is updated as the configured maximum power rating of the port, P_ALLOC_p=P_PORT_p, where P_PORT_p is the configured maximum power rating of the port p.

In the second case of HR power distribution, with IDR mode on port p, at block 108, the available power is checked against the maximum power rating of the port (i.e. whether P_AVAIL≥P_PORT_p−P_ALLOC_p). If available power is sufficient (i.e. P_AVAIL≥P_PORT_p evaluates to TRUE/Y), at block 114, the available power is directly reduced as per maximum power rating of the port, P_AVAIL=P_AVAIL−(P_PORT_p−P_ALLOC_p). If the available power is not sufficient (i.e. P_AVAIL≥P_PORT_p−P_ALLOC_p evaluates to FALSE/N), at block 110, P_DELTA is computed as the power shortage in available power, P_DELTA=(P_INIT−P_ALLOC_p)−P_{AVAIL} and, at block 112, P_DELTA amount of power is deallocated from other ports, to be made available for port p, using the subroutine POWER_DEALLOCATION. After ensuring the power P_INIT is available to be allocated to port p, available power is accordingly updated at block 114, P_AVAIL=P_AVAIL−(P_PORT_p−P_ALLOC_p). At block 116, the allocated power to port p is updated as P_ALLOC_p=P_PORT_p, thus allocating maximum port power rating to port p.

In the third case of CCR power distribution configuration or HR power distribution configuration, with CCR mode on port p, at block 118, P_INIT is assigned as 7.5 W in case the connector on port p is Type-A connector at block 120, else assigned as 15 W assuming the connector on port p is Type-C connector at block 122. At block 132, the available power (P_AVAIL) is checked against the extra power required above already allocated power to reach P_INIT power level (i.e. whether P_AVAIL≥P_INIT−P_ALLOC_p). If available power is sufficient (i.e. P_AVAIL≥P_INIT−P_ALLOC_p evaluates to TRUE/Y), at block 134, the available power is accordingly reduced, P_AVAIL=P_AVAIL−(P_INIT−P_ALLOC_p). Else, if the available power is not sufficient (i.e. P_AVAIL≥P_INIT−P_ALLOC_p evaluates to FALSE/N), at block 140, P_DELTA is computed as the power shortage in available power, P_DELTA=(P_INIT−P_ALLOC_p)−P_AVAIL, and, at block 142, P_DELTA amount of power is deallocated from other ports, to be made available for port p, using the subroutine POWER_DEALLOCATION. After ensuring the power P_INIT is available to be allocated to port p, available power is accordingly updated at block 134, P_AVAIL=P_AVAIL−(P_INIT−P_ALLOC_p). At block 136, the allocated power to port p is updated as P_ALLOC_p=P_INIT, and at block 138, port index p is appended to a list, Port Connection OrderList, to keep a track of the order of connection of sinks to the multiport power sourcing device.

After updating the allocated power for port p in any of the above three cases, at block 130, the first set of instructions inform the second set of instructions for each port, about the allocated power P_ALLOC_p.

At block 144, the first set of instructions execute for a power negotiation alert on a portp, the power negotiation alert coupled with information such as the negotiated power (P_NEG), give back power (P_GIVE_BACK) with respect to the sink connected on port p, and the SinkReqNotMet flag to indicate the insufficiency of power allocated to sink. At block 144, the available power is updated as per the new negotiated power, P_AVAIL=P_AVAIL+P_ALLOC_p−P_NEG, and the allocated power to port p is updated as P_ALLOC_p=P_NEG. At block 146, the SinkReqNotMet flag from the alert information is updated for port p and SinkReqNotMet flags for all other ports are unmasked. At block 148, P_GIVE_BACK from the alert information is updated for port p as P_GIVE_BACK_p. At block 152, the power allocated to port p is checked to be equal to the maximum power rating of the port (i.e., whether P_ALLOC_p==P_PORT_p) and whether the SinkReqNotMetflag is asserted for port p. If both the conditions, P_ALLOC_p==P_PORT_p and SinkReqNotMet asserted, evaluate to TRUE/Y, then at block 152, SinkReqNotMet flag is cleared for port p to indicate that the sink requirements connected on port p cannot be met as port is already allocated with maximum power rating.

At block 154, the first set of instructions execute for a power request alert for a power P_REQ made by sink connected on port p, where the sink request P_REQ is limited to the maximum port power rating P_PORT_p and P_ON_DEMAND_LIM and the resultant power number is considered as effective sink power requirement on port p, P_SNK_p, i.e., P_SNK_p=MIN(P_REQ, P_PORT_p, P_ON_DEMAND_LIM), where P_ON_DEMAND_LIM is the maximum power that a sink is allowed to be upgraded in a single power upgrade.

At block 156, the first set of instructions execute for a sink power requirement detection/discovery response from second set of instructions, where the sink power requirement P_REQ is limited to maximum port power rating P_PORT_p and the resultant power number is considered as effective sink power requirement on port p, P_SNK_p, i.e., P_SNK_p=MIN(P_REQ, P_PORT_p).

After deducing the effective sink power requirement at block 154 or at block 156 as mentioned above, the configuration of power distribution order is evaluated at block 158. If the power distribution order is configured to be BALANCED (Y), then, at block 160, integer k is compared with highest integer among all connected port indices. If k is less than highest integer among all connected port indices (Y), then, at block 170, next higher integer among all connected port indices is retrieved into k, using the subroutine GET_PORT_IDX_FOR_SERVICE. Else, at block 160, if k is not less than highest integer among all connected port indices (N), then, at block 184, k is re-initialized to −1 and, at block 162, power allocation is done to port p, using the subroutine POWER_ALLOCATION. At block 158, if the power distribution order is configured to be other than BALANCED (N), then, directly at block 162, power allocation is done to port p, using the subroutine POWER_ALLOCATION.

At block 166, the first set of instructions execute for a no pending alert or response to be serviced and if SinkReqNotMet flag is asserted for at least one port. The first set of instructions check, at block 166, if power is available for servicing a needy port (a port with SinkReqNotMet flag set to 1 and not masked is henceforth termed as “needy” port). If P_{AVAIL}>0 is FALSE/N, then, at block 174, SinkReqNotMet flags for all ports are masked, due to unavailability of power to service any needy port. Else, if P_AVAIL>0 is TRUE/Y, then, at block 168, a dynamic list of port indices, NeedyPorts List, is newly created or updated to contain only the port indices for which SinkReqNotMet is set to 1 and SinkReqNotMet flag is not masked. At block 170, next port index, among NeedyPorts List, to be serviced is retrieved into the integer k, using the subroutine GET_PORT_IDX_FOR_SERVICE. At block 172, the second set of instructions is requested to discover/detect sink power profile/requirement on the selected port index k. At block 186, the configuration of power distribution order is evaluated, and integer k is compared with highest integer among all connected port indices. If the power distribution order is configured to be BALANCED and k is less than highest integer among all connected port indices (Y), then, at block 170, next port index, among NeedyPorts List, to be serviced is retrieved into the integer k, using the subroutine GET_PORT_IDX_FOR_SERVICE.

At block 176, the first set of instructions execute for a sink disconnection detection alert on a CCR or HR port, and take back the allocated power to the port into available power, P_AVAIL=P_AVAIL+(P_ALLOC_p−P_MIN_p). The allocated power to port p is updated as minimum port power rating, P_ALLOC_p=P_MIN_p. At block 178, the first set of instructions inform the second set of instructions for each port, about the allocated power P_ALLOC_p. At block 180, SinkReqNotMetflag is cleared for port p, and port index p is removed from Port Connection Order List and NeedyPortsList. At block 182, SinkReqNotMet flags for all the ports are unmasked.

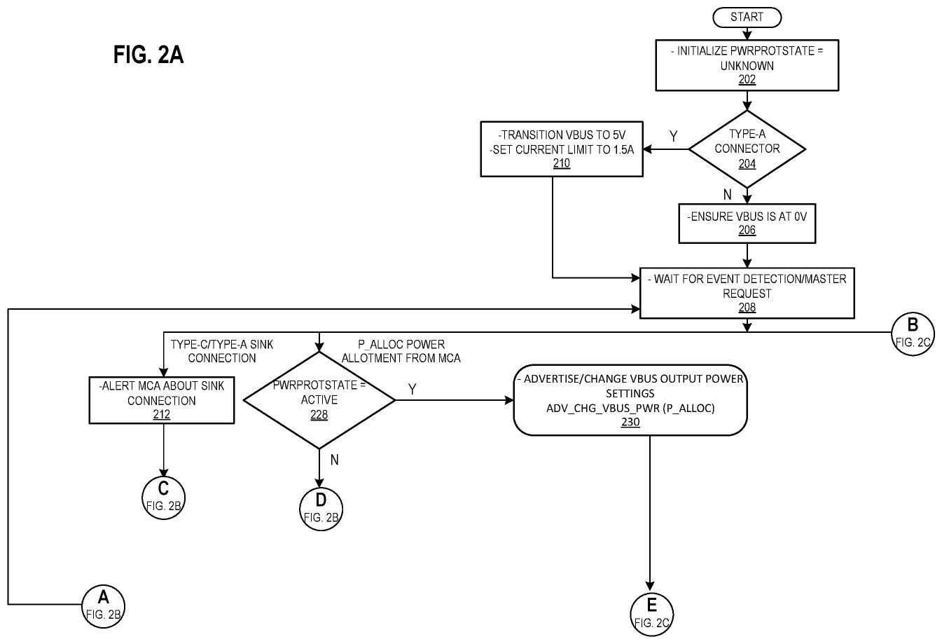

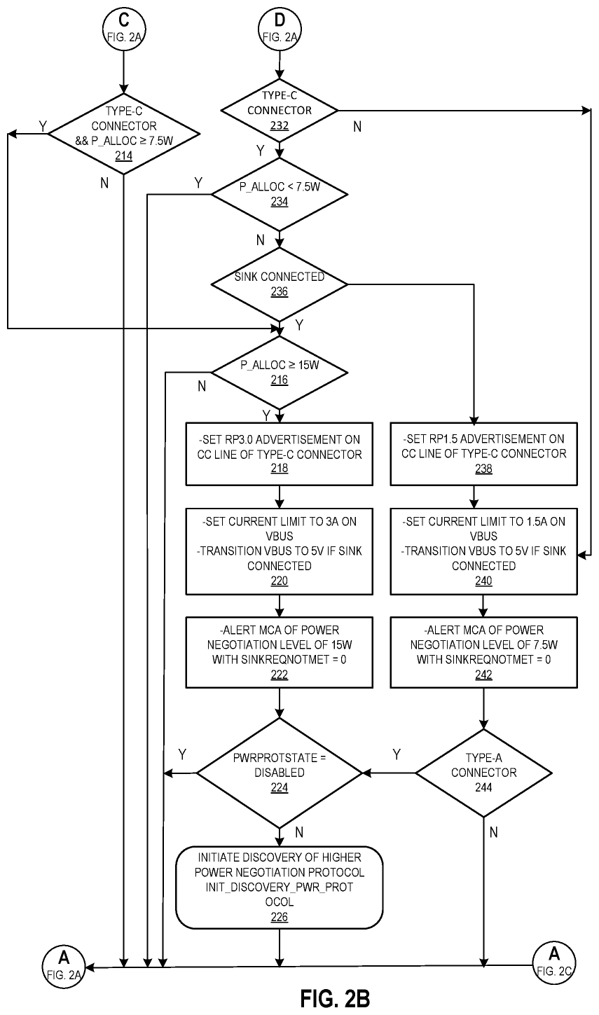

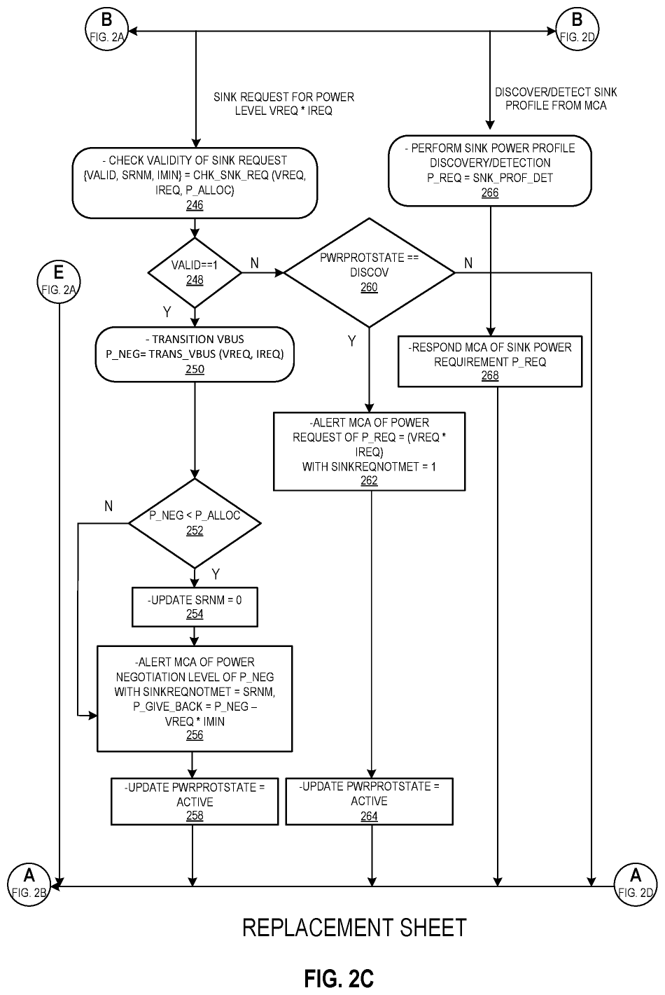

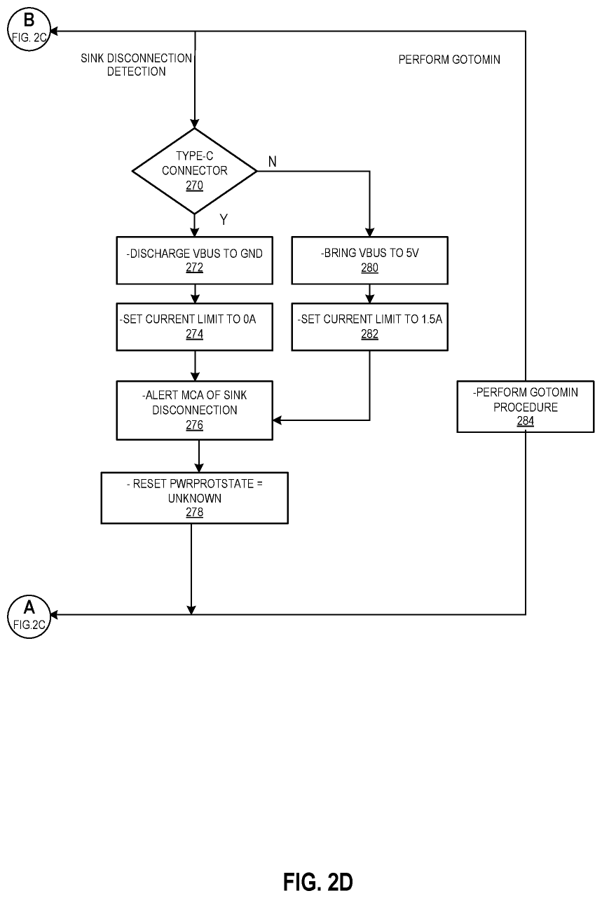

FIGS. 2A to 2D illustrate an exemplary representation of a second set of instructions, for performing operations pertaining to actual supply of power over a single port of the power sourcing device in accordance with an embodiment of the present disclosure.

In an embodiment, with respect to FIGS. 2A to 2D, at power-on, initialization is performed at block 202, where PWR_PROT_STATE is initialized to UNKNOWN. At block 204, the connector type is checked on the associated port. If the connector type is Type-A (Y), then, at block 210, VBUS of Type-A connector is transitioned to 5V with a current limit setting of 1.5 A. Else, if the connector type is Type-C(N), then, at block 206, VBUS of Type-C connector is ensured to be discharged fully. Post ensuring initial state of VBUS, at block 208, the second set of instructions execute to wait for a new request from first set of instructions, or an event detection from physical Type-A/Type-C port. The second set of instructions are executed according to the type of the request or the event.

At block 212, the second set of instructions execute for a sink connection detection on Type-C/Type-A port. At block 212, the second set of instructions alert MCA about sink connection detection. At block 214, the second set of instructions check, if the connector type is Type-C and whether the allocated power to the port (by the first set of instructions) (P_ALLOC) is greater than or equal to 7.5 W. If the connector is not Type-C (in other words, connector is Type-A), or if the P_ALLOC is less than 7.5 W (N), then the second set of instructions return back to block 208, waiting for a new request or event. Else, if the connector is Type-C and the P_ALLOC is greater than or equal to 7.5 W (Y), then, at block 216, the second set of instructions check if the P_ALLOC is greater than or equal to 15 W.

At block 214, if the connector is Type-C and P_ALLOC is greater than or equal to 7.5 W (Y), then, at block 216, the second set of instructions check whether P_ALLOC is greater than or equal to 15 W. If P_ALLOC is less than 15 W (N), then the second set of instructions perform no action for supplying VBUS, and return to block 208, waiting for a new request or event. Else, if, at block 216, P_ALLOC is greater than or equal to 15 W (Y), then, at block 218, second set of instructions set Rp-3.0 A advertisement on CC line of Type-C connector. At block 220, the current limit on VBUS is set to 3 A, and VBUS is transitioned to 5V, only if the sink connection is already detected. At block 222, the second set of instructions alert the first set of instruction for power negotiation level of 15 W, with SinkReqNotMet set to 0. At block 224, the second set of instructions check for PWR_PROT_STATE being DISABLED. If PWR_PROT_STATE is DISABLED (Y), then the second set of instructions return to block 208, waiting for a new request or event. Else, if PWR_PROT_STATE is not DISABLED (N), then discovery of higher power negotiation protocol is initiated through INIT_DISCOVERY_PWR_PROTOCOL subroutine.

At block 228, the second set of instructions execute for a power allotment request from the first set of instructions, where the second set of instructions check for PWR_PROT_STATE being ACTIVE. If PWR_PROT_STATE is not ACTIVE (N), then, at block 232, the second set of instructions check for the connector type being Type-C. If the connector is Type-C(Y), then, at block 234, the second set of instructions check whether the allocated power, P_ALLOC, is less than 7.5 W. If P_ALLOC is less than 7.5 W (Y), then the second set of instructions perform no action for supplying VBUS, and return to block 208, waiting for a new request or event. Else, if, at block 234, P_ALLOC is greater than or equal to 7.5 W (N), then, at block 236, the second set of instructions check if a sink connection is already detected.

At block 236, if the sink connection is already detected (Y), then, at block 216, the second set of instructions check whether P_ALLOC is greater than or equal to 15 W. If P_ALLOC is less than 15 W (N), then the second set of instructions perform no action for supplying VBUS, and return to block 208, waiting for a new request or event. Else, if, at block 216, P_ALLOC is greater than or equal to 15 W (Y), then, at block 218, second set of instructions set Rp-3.0 A advertisement on CC line of Type-C connector. At block 220, the current limit on VBUS is set to 3 A, and VBUS is transitioned to 5V, only if the sink connection is already detected. At block 222, the second set of instructions alert the first set of instruction for power negotiation level of 15 W, with SinkReqNotMet set to 0. At block 224, the second set of instructions check for PWR_PROT_STATE being DISABLED. If PWR_PROT_STATE is DISABLED (Y), then the second set of instructions return to block 208, waiting for a new request or event. Else, if PWR_PROT_STATE is not DISABLED (N), then discovery of higher power negotiation protocol is initiated through INIT_DISCOVERY_PWR_PROTOCOL subroutine.

At block 236, if the sink connection is not already detected (N), then, at block 238, second set of instructions set Rp-1.5 A advertisement on CC line of Type-C connector. At block 240, the current limit on VBUS is set to 3 A, and VBUS is transitioned to 5V, only if the sink connection is already detected. At block 242, the second set of instructions alert the first set of instruction for power negotiation level of 7.5 W, with SinkReqNotMet set to 0. At block 244, the second set of instructions check if the connector type is Type-A. If the connector type is Type-A (Y), then, at block 224, the second set of instructions check for PWR_PROT_STATE being DISABLED. If PWR_PROT_STATE is DISABLED (Y), then the second set of instructions return to block 208, waiting for a new request or event. Else, if PWR_PROT_STATE is not DISABLED (N), then discovery of higher power negotiation protocol is initiated through INIT_DISCOVERY_PWR_PROTOCOL subroutine. At block 244, if the connector type is not Type-A (N), then the second set of instructions return to block 208, waiting for a new request or event.

At block 232, if the connector is not Type-C(N), then, at block 240, the current limit on VBUS is set to 3 A, and VBUS is transitioned to 5V, only if the sink connection is already detected. At block 242, the second set of instructions alert the first set of instruction for power negotiation level of 7.5 W, with SinkReqNotMet set to 0. At block 244, the second set of instructions check if the connector type is Type-A. If the connector type is Type-A (Y), then, at block 224, the second set of instructions check for PWR_PROT_STATE being DISABLED. If PWR_PROT_STATE is DISABLED (Y), then the second set of instructions return to block 208, waiting for a new request or event. Else, if PWR_PROT_STATE is not DISABLED (N), then discovery of higher power negotiation protocol is initiated through INIT_DISCOVERY_PWR_PROTOCOL subroutine. At block 244, if the connector type is not Type-A (N), then the second set of instructions return to block 208, waiting for a new request or event.

At block 228, if the PWR_PROT_STATE is ACTIVE (Y), then, at block 230, the second set of instructions advertise or change VBUS output power settings as per P_ALLOC allocated power using the ADV_CHG_VBUS_PWR subroutine.

At block 246, the second set of instructions execute for a power request event from the connected sink, where the requested voltage is VREQ and requested current is IREQ. At block 246, validity of sink request for VREQ, IREQ against the allocated power P_ALLOC is checked using the subroutine CHK_SNK_REQ. The subroutine returns a response containing whether the sink request is VALID, the value of SinkReqNotMet flag and the value of minimum operating current IMIN, if advertised by the sink in the request.

At block 248, the second set of instructions check if the VALID response from the subroutine CHK_SNK_REQ is set to 1. If the VALID response is set to 1, then, at block 250, the second set of instructions transition VBUS to VREQ voltage with IREQ current limit setting using the TRANS_VBUS subroutine. The TRANS_VBUS subroutine returns a response containing a P_NEG power negotiation level as per the transitioned VBUS. At block 252, the second set of instructions check if the P_NEG is less than P_ALLOC. If P_NEG<P_ALLOC is TRUE/Y, the SinkReqNotMet flag is cleared to 0, to avoid any false triggering of SinkReqNotMet flag. At block 242, the second set of instructions alert the first set of instruction for power negotiation level of P_NEG power, with SinkReqNotMet flag set as per the response as per block 246 and block 254, and P_GIVE_BACK set to P_GIVE_BACK=P_NEG−VREQ*IMIN. At block 252, if P_NEG<P_ALLOC is FALSE/N, then directly, at block 242, the second set of instructions alert the first set of instruction for power negotiation level of P_NEG power, with SinkReqNotMet flag set as per the response as per block 246 and block 254, and P_GIVE_BACK set to P_GIVE_BACK=P_NEG−VREQ*IMIN. At block 258, the PWR_PROT_STATE is updated to ACTIVE.

At block 248, if the VALID response is not set to 1, then at block 260, the second set of instructions check if the PWR_PROT_STATE is set to DISCOV. If the PWR_PROT_STATE is set to DISCOV (Y), then, at block 262, the second set of instructions alert the first set of instructions for power request alert with P_REQ=VREQ*IREQ and SinkReqNotMet flag set to 1. At block 264, the PWR_PROT_STATE is updated to ACTIVE. At block 260, if the PWR_PROT_STATE is not set to DISCOV (N), then the second set of instructions return to block 208, waiting for a new request or event.

At block 266, the second set of instructions execute for a sink profile discovery/detection request from the first set of instructions, where the second set of instructions perform sink profile discovery/detection using the SNK_PROF_DET subroutine. The SNK_PROF_DET subroutine returns a response containing P_REQ as sink power profile discovered/detected. At block 268, the second set of instructions inform the first set of instructions about the sink power requirement response as P_REQ.

At block 270, the second set of instructions execute for a sink disconnection detection alert from the connector. At block 270, the second set of instructions check if the connector type is Type-C. If the connector type is Type-C(Y), then, at block 272, VBUS is discharged fully, and at block 274, the current limit setting is cleared. Else, if the connector type is not Type-C(N), then, at block 280, VBUS is set to 5V, and, at block 282, current limit setting is set to 1.5 A. At block 276, the second set of instructions alert the first set of instructions for sink disconnection detection. At block 278, the PWR_PROT_STATE is set to UNKNOWN.

At block 284, the second set of instructions execute for a GotoMin request from the first set of instructions, where the second set of instructions perform the requested GotoMin procedure.

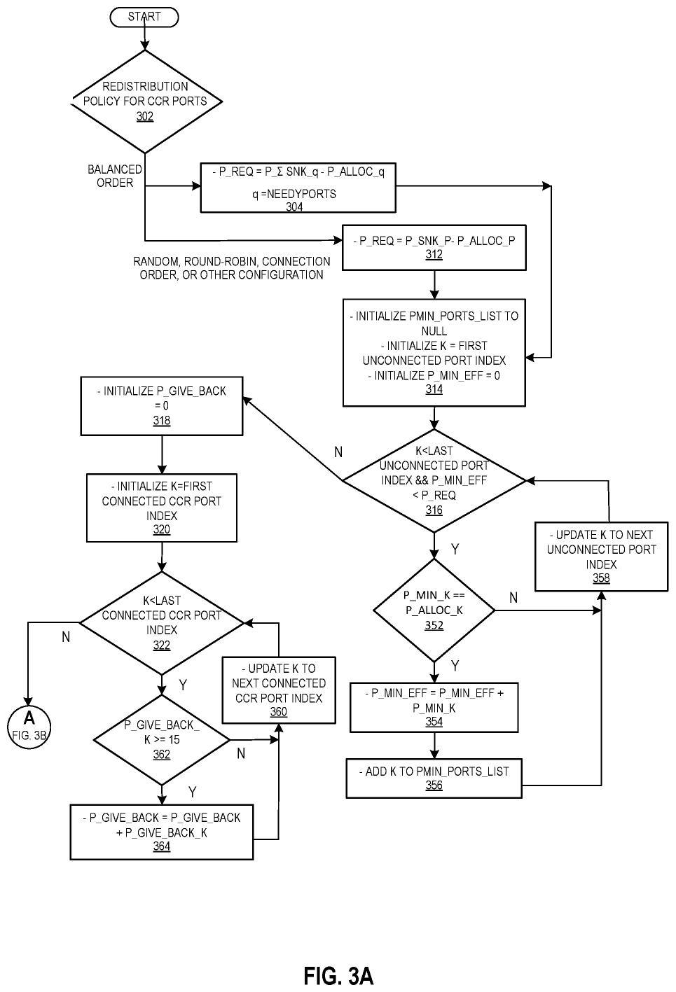

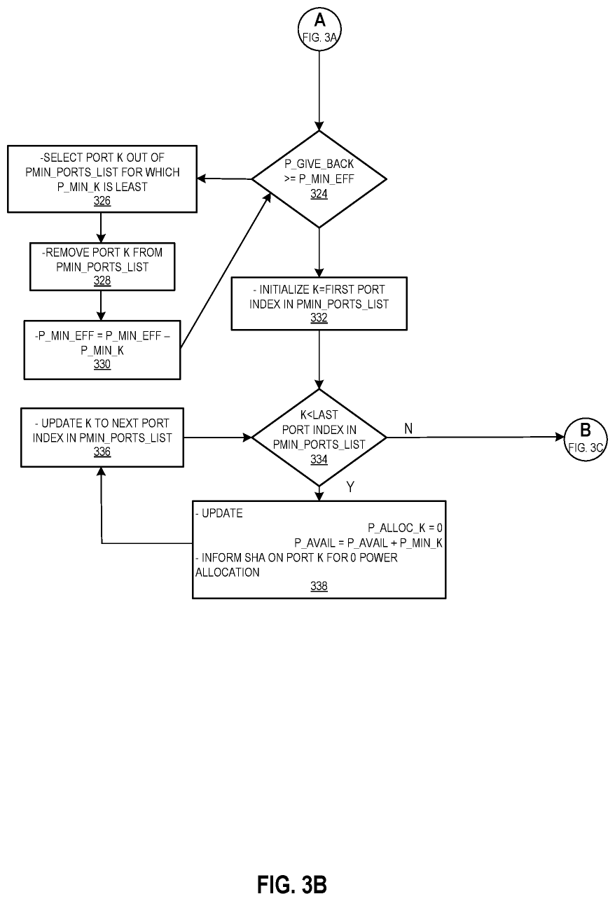

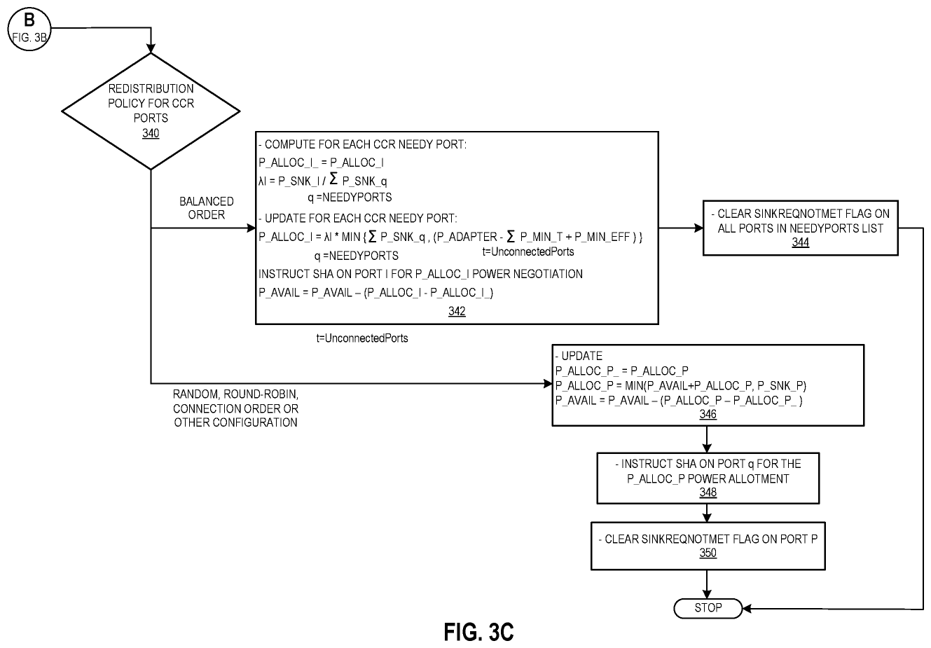

FIGS. 3A to 3C illustrate an exemplary representation of a POWER_ALLOCATION sub-routine of the MCA, for dynamic allocation of power to a port index p in a multiport power sourcing device in accordance with an embodiment of the present disclosure.

At block 302, the first set of instructions execute to check the configured redistribution policy for CCR ports.

At block 304, the first set of instructions execute for redistribution policy configuration set to BALANCED order, where required power, P_REQ, is evaluated as the cumulative power requirement of all the connected ports which are part of NeedyPorts List. Hence, P_REQ is evaluated as per the following equation, P_REQ=Σ_{q=NeedyPorts}(P_SNK_q−P_ALLOC_q).

At block 312, the first set of instructions execute for redistribution policy configuration set to RANDOM, ROUND-ROBIN, CONNECTION order or any other configuration, where required power, P_REQ, is evaluated as the power requirement of port p, for which power allocation is to be performed. Hence, P_REQ=P_SNK_p−P_ALLOC_p.

After evaluating P_REQ, at block 314, a list, PMIN_ports_list is initialized as empty list, a loop variable k is initialized to the first unconnected port index and a power-related variable P_MIN_eff is initialized to 0. PMIN_ports_list is intended to store a list of unconnected port indices that are presently allocated with the configured minimum power rating, and the minimum power from the respective ports can be fully taken back into available power, with a guarantee that the minimum power rating can be re-allocated, on connection detection. P_MIN_eff is intended to store the cumulative of taken-back minimum power from the above-mentioned unconnected ports.

At block 316, the first set of instructions check whether the loop variable k is less than the last unconnected port index and the cumulative taken-back minimum power P_MIN_eff is less than the required power P_REQ. If k is less than the last unconnected port index and P_MIN_eff is less than P_REQ (Y), then, at block 352, the first set of instructions check whether the configured minimum power rating of port k, P_MIN_k is the same as the present allocated power to port k, P_ALLOC_k. If P_MIN_k is the same as P_ALLOC_k (Y), then, at block 354, P_MIN_k is added to the cumulative taken-back minimum power P_MIN_eff, and at block 356, index k is appended to the PMIN_ports_list. At block 358, k is updated to the next unconnected port index. If, at block 352, P_MIN_k is not the same as P_ALLOC_k (N), then, at block 358, k is updated to the next unconnected port index. After updating k, the loop re-runs to check at block 316, whether the loop variable k is less than the last unconnected port index and P_MIN_eff is less than P_REQ.

At block 316, if k is greater than the last unconnected port index or if P_MIN_eff is greater than or equal to P_REQ (N), then, at block 318, a power-related variable, P_GIVE_BACK is initialized to 0. P_GIVE_BACK is intended to store the cumulative power available from the ports connected to a give-back enabled sinks, in order to check whether the cumulative give-back power can be utilized to service minimum power allocation to the unconnected ports from which the minimum power has been taken away. At block 320, a loop variable k is initialized to the first connected CCR port index.

At block 322, the first set of instructions check whether the loop variable k is less than the last connected CCR port index. If k is less than last connected CCR port index (Y), then, at block 362, the first set of instructions check whether the give-back power from sink connected to port k is greater than or equal to 15 W. If give-back power from sink connected to port k is greater than or equal to 15 W (Y), then, at block 364, the give-back power from port k is added to the cumulative power P_GIVE_BACK. At block 360, k is updated to the next connected CCR port index. If, at block 362, give-back power from sink connected to port k is less than 15 W (N), then, at block 360, the first set of instructions check. After updating k, the loop re-runs to check at block 322, whether the loop variable k is less than the last connected CCR port index.

At block 322, if k is greater than the last connected CCR port index (N), then, at block 324, the cumulative give-back power P_GIVE_BACK is greater than or equal to the cumulative taken-back minimum power P_MIN_eff. If P_GIVE_BACK is less than P_MIN_eff (N), the PMIN_ports_list is updated to remove a number of port indices such than P_GIVE_BACK is sufficient to service the new P_MIN_eff after removing the number of port indices. At block 326, a port index k is selected from the PMIN_ports_list such that the minimum power rating configured for port k is the least among all the port indices present in the PMIN_ports_list. At block 328, the selected port index k is removed from the PMIN_ports_list, and at block 330, P_MIN_eff is updated by subtracting the P_MIN_k from P_MIN_eff. At block 324, P_GIVE_BACK is again compared with the updated P_MIN_eff.

If, at block 324, P_GIVE_BACK is greater than or equal to P_MIN_eff (Y), then, at block 332, a loop variable k is initialized to the first port index in PMIN_ports_list. At block 334, the first set of instructions check whether k is less than the last port index in PMIN_ports_list. If k is less than the last port index in PMIN_ports_list (Y), then, at block 338, power allocated to port k is made OW (P_ALLOC_k is set to OW), available power is increased with the taken-back minimum power from port k (P_AVAIL=P_AVAIL+P_MIN_k), and the second set of instructions associated with port k are informed about the updated OW allocated power. At block 336, k is updated to the next port index in PMIN_ports_list. The loop re-runs to check at block 334, whether k is less than the last port index in PMIN_ports_list.

If, at block 334, k is greater than the last port index in PMIN_ports_list (N), then, at block 340, the first set of instructions execute to check the configured redistribution policy for CCR ports.

At block 342, the first set of instructions execute for redistribution policy configuration set to BALANCED order, where, for each port index i present in NeedyPorts List, P_ALLOC_i_ is assigned as the present allocated power on port index i (P_ALLOC_i). A power ratio λi is computed for each CCR port, which is present in NeedyPorts List, where λi is defined as the ratio of sink power requirement on port i (P_SNK_i) to the sum of sink power requirements on all the ports present in NeedyPorts List (Σ_{q=NeedyPorts}P_SNK_q). For BALANCED redistribution policy, the absolute power that can be redistributed in the multiport system is P_ADAPTER−Σ_{t=Unconnected Ports}P_MIN_t+P_MIN_eff, where the P_MIN_eff is the taken-back minimum power to the available power reserve. The total power required by sinks connected to all ports which are present in NeedyPorts List is Σ_{q=NeedyPorts}P_SNK_q. Hence, the overall available redistribution power is the minimum of the total power required by needy ports and the absolute power that can be redistributed. For BALANCED redistribution policy, the updated allocated power (P_ALLOC_i) for each needy port i is defined as λi times the overall available redistribution power. For each needy port i, P_ALLOC_i is hence computed as λi×min(Σ_{q=NeedyPorts}P_SNK_q, P_ADAPTER−Σ_{t=Unconnected Ports}P_MIN_t+P_MIN_eff).

At block 342, the first set of instructions inform the second set of instructions associated with each of the port index present in NeedyPorts List about the updated allocated power P_ALLOC_i for each needy port i. For each port index i present in NeedyPortsList, the available power is updated as per the new allocated power, P_AVAIL=P_AVAIL−(P_ALLOC_i−P_ALLOC_i_). At block 344, SinkReqNotMet flag is cleared for all port indices present in NeedyPorts List.

At block 346, the first set of instructions execute for redistribution policy configuration set to RANDOM, ROUND-ROBIN, CONNECTION order or any other configuration, where P_ALLOC_p_ is assigned to the present allocated power on port index p (P_ALLOC_p), where the port index p corresponds to the port on which the power allocation is to be performed. Since the maximum power than can be allocated to the port p is the sum of available power (P_AVAIL) and the already allocated power to port p (P_ALLOC_p), the new power to be allocated to port p can be computed as P_ALLOC_p=min(P_AVAIL+P_ALLOC_p, P_SNK_p). The available power is reduced as per the excess allocated power, P_AVAIL=P_AVAIL−(P_ALLOC_p−P_ALLOC_p_). At block 348, the first set of instructions inform the second set of instructions associated to port p, about the allocated power P_ALLOC_p. At block 350, SinkReqNotMet flag is cleared for port index p.

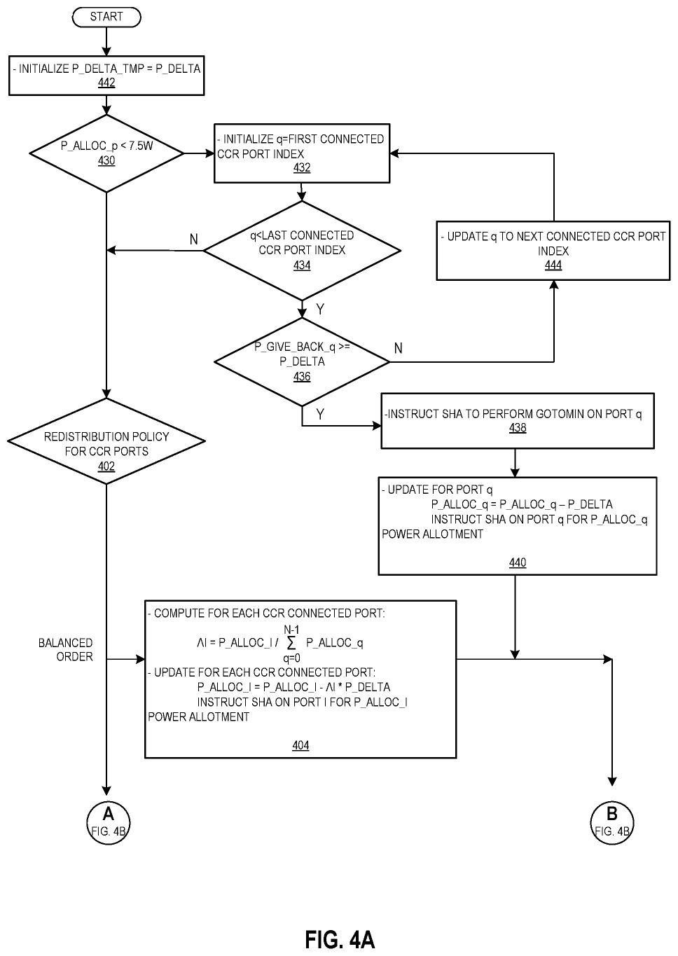

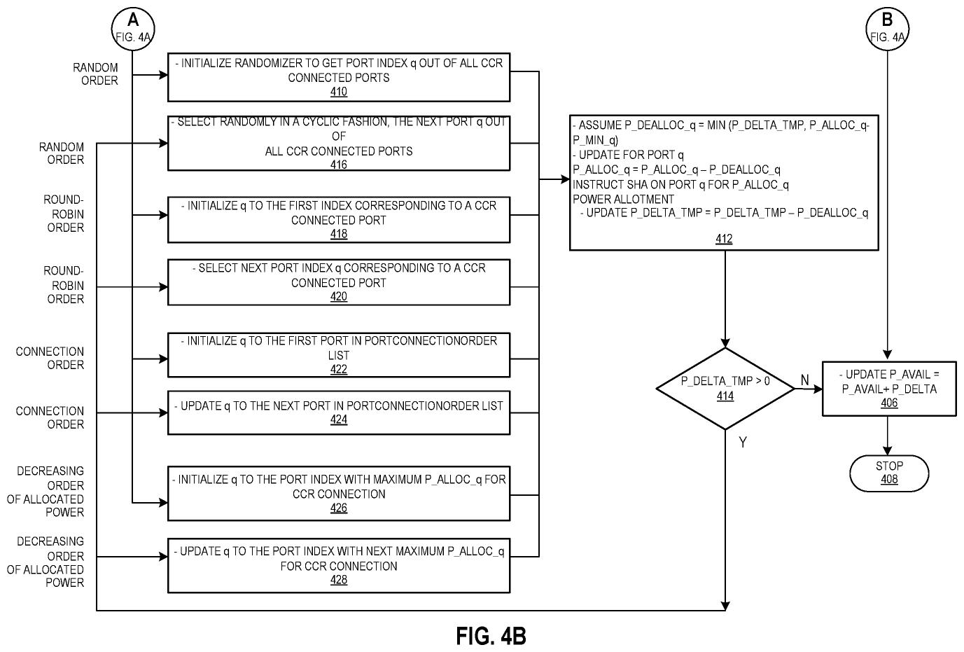

FIGS. 4A to 4B illustrate an exemplary representation of a POWER_DEALLOCATION sub-routine of the MCA for dynamic de-allocation of power in a multiport power sourcing device in accordance with an embodiment of the present disclosure.

POWER_DEALLOCATION subroutine of the first set of instructions is executed when available power (P_AVAIL) is not sufficient to allocate the required amount of power to a portp on its sink connection detection, where required amount of the power is equal to port power rating (P_PORT_p) in case of an IDR port of HR power distribution, 7.5 W in case of a Type-A CCR port and 15 W in case of a Type-C CCR port. Assuming power shortage in the P_AVAIL is P_DELTA, where P_DELTA=(P_PORT_p−PALLOC_p)−P_AVAIL in case of an IDR port of HR power distribution, and P_DELTA=(P_INIT−P_ALLOC_p)−P_AVAIL in case of CCR port. The POWER_DEALLOCATION subroutine reduces the power allocated to the already connected ports by a total of P_DELTA and adds it up to P_AVAIL, so that the first set of instructions can allocate it to the port p.

At block 442, P_DELTA_TMP is initialized to be the same as the P_DELTA power de-allocation requirement. At block 430, the first set of instructions check whether the power allocated to port p (P_ALLOC_p) is less than 7.5 W which is the minimum power required by a port to supply VBUS as per the USB Type-C specification. If P_ALLOC_p is less than 7.5 W (Y), then, at block 432, a loop variable q is initialized to the first connected CCR port index. At block 434, the first set of instructions check whether q is less than the last connected CCR port index. If q is less than the last connected CCR port index, then, at block 436, the first set of instructions check whether the give-back power on port q from the sink connected to the port q is sufficient to service the P_DELTA de-allocation requirement, i.e., whether P_GIVE_BACK_q≥P_DELTA, where P_GIVE_BACK_q is the give-back power associated to port q. If P_GIVE_BACK_q is less than P_DELTA (N), then, at block 444, loop variable q is updated to the next connected CCR port index and the loop re-runs at block 434 to check whether q is less than the last connected CCR port index. If, at block 434, P_GIVE_BACK_q is greater than or equal to P_DELTA (Y), then, at block 438, the first set of instructions instruct the second set of instructions associated with port q to perform GotoMin message sequencing, as per the USB Power Delivery specification, so that the sink connected to port q reduces its operating current in accordance with the give-back power advertised by the connected sink. At block 440, the power allocated to port q is reduced by the P_DELTA requirement and the second set of instructions are informed about the allocated power, P_ALLOC_q (P_ALLOC_q=P_ALLOC_q−P_DELTA). At block 406, the available power P_AVAIL is incremented by P_DELTA power retrieved from the port connected to give-back sink.

At block 434, if q crosses the last connected CCR port index (N), this implies that all the connected CCR ports are checked and none of the ports have GiveBack power greater than P_DELTA, and then, at block 402, the first set of instructions execute to check the configured redistribution policy for CCR ports.

At block 404, the first set of instructions execute for redistribution policy configuration set to BALANCED order, where a power ratio λi is computed for each CCR connected port i, where λi is defined as the ratio of power allocated to port i (P_ALLOC_i) to the sum of power allocated to all CCR connected ports (Σ_{q=Connected CCR ports}P_ALLOC_q). Further, at block 404, power allocated to each connected CCR port i is reduced as per the power ratio according to the equation P_ALLOC_i=P_ALLOC_i−λi×P_DELTA and the second set of instructions are informed about the updated allocated power P_ALLOC_i. At block 406, the available power P_AVAIL is incremented by P_DELTA power retrieved from the connected CCR ports in BALANCED order.

At block 404, the first set of instructions execute for redistribution policy configuration set to RANDOM order, where a randomizer is initialized to get a random port index q out of all the CCR connected ports. At block 412, maximum amount of the power that can be deallocated from port q (P_DEALLOC_q) is computed which is equal to minimum of the two of P_DELTA_TMP and excess power allocated to port q above the minimum power rating, P_ALLOC_q−P_MIN_q. This ensures that at least P_MIN_q remains allocated to the port after the power deallocation. Further, at block 412, P_DEALLOC_q is reduced from P_ALLOC_q and the updated allocated power is informed to the second set of instructions associated with port q. Further, at block 412, P_DELTA_TMP is updated by reducing the deallocated power as P_DELTA_TMP=P_DELTA_TMP−P_DEALLOC_q, where P_DELTA_TMP denotes the amount of power that still needs to be deallocated from the other connected CCR ports to satisfy P_DELTA power deallocation requirement. At block 414, the first set of instructions check whether P_DELTA_TMP is non-zero, i.e., whether power deallocation is to be performed on more connected ports. If P_DELTA_TMP is less than or equal to 0 i.e. no further deallocation is required (N), then, at block 406, the available power P_AVAIL is incremented by P_DELTA power retrieved from the connected CCR ports in RANDOM order. Else if, at block 414, P_DELTA_TMP is greater than 0, then, at block 416, next port index q is selected out of the CCR connected ports in a cyclic random fashion and blocks 412, 414, 416 are repeated until P_DELTA_TMP is less than or equal to 0.

At block 418, the first set of instructions execute for redistribution policy configuration set to ROUND-ROBIN order, where q is initialized with the first port index corresponding to a CCR connected port. At block 412, maximum amount of the power that can be deallocated from port q (P_DEALLOC_q) is computed which is equal to minimum of the two of P_DELTA_TMP and excess power allocated to port q above the minimum power rating, P_ALLOC_q−P_MIN_q. Further, at block 412, P_DEALLOC_q is reduced from P_ALLOC_q and the updated allocated power is informed to the second set of instructions associated with port q. Further, at block 412, P_DELTA_TMP is updated by reducing the deallocated power as P_DELTA_TMP=P_DELTA_TMP−P_DEALLOC_q. At block 414, the first set of instructions check whether P_DELTA_TMP is non-zero. If P_DELTA_TMP is less than or equal to 0 (N), then, at block 406, the available power P_AVAIL is incremented by P_DELTA power retrieved from the connected CCR ports in RANDOM order. Else if, at block 414, P_DELTA_TMP is greater than 0, then, at block 420, q is updated to the next port index corresponding to a CCR connected port and blocks 412, 414, 420 are repeated until P_DELTA_TMP is less than or equal to 0.

At block 422, the first set of instructions execute for redistribution policy configuration set to CONNECTION order, where q is initialized with the first port index in the Port Connection Order List. At block 412, maximum amount of the power that can be deallocated from port q (P_DEALLOC_q) is computed which is equal to minimum of the two of P_DELTA_TMP and excess power allocated to port q above the minimum power rating, P_ALLOC_q−P_MIN_q. Further, at block 412, P_DEALLOC_q is reduced from P_ALLOC_q and the updated allocated power is informed to the second set of instructions associated with port q. Further, at block 412, P_DELTA_TMP is updated by reducing the deallocated power as P_DELTA_TMP=P_DELTA_TMP−P_DEALLOC_q. At block 414, the first set of instructions check whether P_DELTA_TMP is non-zero. If P_DELTA_TMP is less than or equal to 0 (N), then, at block 406, the available power P_AVAIL is incremented by P_DELTA power retrieved from the connected CCR ports in RANDOM order. Else if, at block 414, P_DELTA_TMP is greater than 0, then, at block 424, q is updated to the next port index in the Port Connection Order List and blocks 412, 414, 424 are repeated until P_{DELTA}_{_{TMP}} is less than or equal to 0.

At block 426, the first set of instructions execute for redistribution policy configuration set to DECREASING order of ALLOCATED POWER, where q is initialized with the first port index having maximum power allocation out of all the connected CCR ports, i.e., port with maximum P_ALLOC_q. At block 412, maximum amount of the power that can be deallocated from port q (P_DEALLOC_q) is computed which is equal to minimum of the two of P_DELTA_TMP and excess power allocated to port q above the minimum power rating, P_ALLOC_q−P_MIN_q. Further, at block 412, P_DEALLOC_q is reduced from P_ALLOC_q and the updated allocated power is informed to the second set of instructions associated with port q. Further, at block 412, P_DELTA_TMP is updated by reducing the deallocated power as P_DELTA_TMP=P_DELTA_TMP−P_DEALLOC_q. At block 414, the first set of instructions check whether P_DELTA_TMP is non-zero. If P_DELTA_TMP is less than or equal to 0 (N), then, at block 406, the available power P_AVAIL is incremented by P_DELTA power retrieved from the connected CCR ports in RANDOM order. Else if, at block 414, P_DELTA_TMP is greater than 0, then, at block 428, q is updated to the next port index having next maximum P_ALLOC_q and blocks 412, 414, 428 are repeated until P_DELTA_TMP is less than or equal to 0.

FIG. 5 illustrates an exemplary representation of a GET_PORT_IDX_FOR_SERVICE sub-routine of the MCA for retrieving the next port index to service for power upgradation in a multiport power sourcing device in accordance with an embodiment of the present disclosure.

GET_PORT_IDX_FOR_SERVICE subroutine of the first set of instructions selects the port on which the sink power profile information must be discovered/detected for performing the power upgradation. GET_PORT_IDX_FOR_SERVICE subroutine selects the next port index based on the power distribution policy on CCR ports and returns the selected port as index k. At block 502, the first set of instructions execute to check the configured redistribution policy for CCR ports.

At block 504, the first set of instructions execute for redistribution policy configuration set to BALANCED order, where the next selected port index k is computed as the next higher integer in the Port Connection Order List.

At block 510, the first set of instructions execute for redistribution policy configuration set to RANDOM order, where the next selected port index k is computed randomly in a cyclic fashion from the NeedyPortsList, where the cyclic fashion selection implies that the same port index is not selected twice until all the port indices in the NeedyPortsList are selected at least once.

At block 512, the first set of instructions execute for redistribution policy configuration set to ROUND-ROBIN order, where the next selected port index k is computed as the next index in the NeedyPorts List in a circular fashion, where the circular fashion selection implies that the next index selected is the higher consecutive index in the NeedyPorts List.

At block 514, the first set of instructions execute for redistribution policy configuration set to CONNECTION order, where the next selected port index k is computed as the next port index from the NeedyPortsList in the order of the sink connection detection on ports, where the connection detection order of ports can be referenced from the Port ConnectionOrderList.

After updating the next port index k based on the power distribution policy, the value of k is returned at block 506.

FIG. 6 illustrates an exemplary representation of an INIT_DISCOVERY_PWR_PROTOCOL subroutine of the SHA for USB PD protocol discovery on initial connection detection of a sink device in accordance with an embodiment of the present disclosure.

INIT_DISCOVERY_PWR_PROTOCOL subroutine of the second set of instructions is executed for discovering the USB PD protocol support in the connected sink device and for discovering the capabilities of the cable through which sink device is connected. At block 602, the second set of instructions check whether an Electronic Marker chip (also termed as E-Marker chip or EMIC) is present in the cable. If cable E-Marker is not detected (N), then, at block 608, maximum current supported by the cable (I_CABLE) is set to the default value of 3 A. If, at block 602, cable E-Marker is detected (Y), then, at block 604, cable capabilities are requested by sending USB PD SOP’ DiscoverIdentity message to the cable plug. At block 606, the second set of instructions check whether the cable capabilities response is received from the cable plug. If cable capabilities response is received, then, at block 630, I_CABLE is updated with the maximum current supported by the cable, i.e., 3A or 5A or any other value as indicated in the cable capabilities response message. Else if, at block 606, if cable capabilities response is not received, then, at block 608, I_CABLE is updated with the default value of 3 A.

At block 610, the second set of instructions execute to check whether a set of custom USB PD SourceCapabilities PDOs/APDOs are configured. If custom SourceCapabilities PDOs/APDOs are configured (Y), then, at block 612, the USB PD SourceCapabilities message is initialized with SourceCapabilities PDOs/APDOs containing the same supply type and the same operating/minimum/maximum voltage as present in the custom configuration. Else if, at block 610, the custom SourceCapabilities PDOs/APDOs are not configured (N), then, at block 628, the SourceCapabilities message is initialized with SourceCapabilities PDOs/APDOs containing Fixed, PPS and/or other normative supply types and the normative operating/minimum/maximum voltage defined in USB Power Delivery specification.

At block 614, POPULATE_SOURCE_CAP_PDOs subroutine is called to populate the current related fields in the SourceCapabilities PDOs/APDOs as per the power allocated to the port by the first set of instructions, i.e., P_ALLOC and as per the SourceCapabilities PDOs/APDOs supply types and voltage values initialized at blocks 612 and 628. At block 616, the populated SourceCapabilities message is sent to the sink.

At block 618, the second set of instructions check whether USB PD communication is supported by the sink based on the response from the sink. If USB PD communication is detected (Y), then, at block 620, PWR_PROT_STATE is updated to DISCOV. Else if, at block 618, USB PD communication is not detected, then, at block 624, the second set of instructions check whether the retry attempts for SourceCapabilities message have exceeded the configured limit. If the retry attempts have not exceeded the configured limit, then, at block 616, the SourceCapabilities message is re-transmitted to the sink and USB PD communication detection is re-evaluated at block 618. Else if, at block 624, the retry attempts have exceeded the configured limit, then, at block 626, PWR_PROT_STATE is updated to DISABLED.

FIG. 7 illustrates an exemplary representation of an ADV_CHG_VBUS_PWR subroutine of the SHA to advertise the SourceCapabilities advertisement in case USB PD is active on the port in accordance with an embodiment of the present disclosure.

ADV_CHG_VBUS_PWR subroutine is executed for advertising the source capabilities to the sink after detecting the USB PD communication support between the source and sink, i.e., after the PWR_PROT_STATE is ACTIVE. At block 702, the second set of instructions check whether the Sink Capability PDOs/APDOs of the connected sink device are already stored. If Sink Capability PDOs/APDOs are already stored (Y), then, at block 704, the USB PD SourceCapabilities message is initialized with SourceCapabilities PDOs/APDOs containing the same supply type and the same operating/minimum/maximum voltage as present in the Sink Capability PDOs/APDOs. Else if, at block 702, Sink Capability PDOs/APDOs are not present (N), then, at block 712, the second set of instructions execute to check whether a set of custom USB PD SourceCapabilities PDOs/APDOs are configured. If custom SourceCapabilities PDOs/APDOs are configured (Y), then, at block 716, the USB PD SourceCapabilities message is initialized with SourceCapabilities PDOs/APDOs containing the same supply type and the same operating/minimum/maximum voltage as present in the custom configuration. Else if, at block 712, the custom SourceCapabilities PDOs/APDOs are not configured (N), then, at block 714, the SourceCapabilities message is initialized with SourceCapabilities PDOs/APDOs containing Fixed, PPS and/or other normative supply types and the normative operating/minimum/maximum voltage defined in USB Power Delivery specification.

After SourceCapabilities PDOs/APDOs are initialized, at block 706, POPULATE_SOURCE_CAP_PDOs subroutine is called to populate the current related fields in the SourceCapabilities PDOs/APDOs as per the power allocated by the first set of instructions to the port, i.e., P_ALLOC and as per the SourceCapabilities PDOs/APDOs supply types and voltage values initialized at block 704/716/714. At block 708, the populated SourceCapabilities message is sent to the sink.

FIG. 8 illustrates an exemplary representation of a POPULATE_SOURCE_CAP_PDOs subroutine of the SHA, in case USB PD is active on the port, in accordance with an embodiment of the present disclosure.

POPULATE_SOURCE_CAP_PDOs subroutine is used for populating the VBUS current related fields of all the SourceCapabilities PDOs/APDOs in the SourceCapabilities message. At block 802, a loop variable, k, to iterate over the SourceCapabilities PDOs/APDOs, is initialized to 0. At block 804, the second set of instructions check whether k is less than the number of SourceCapabilities PDOs/APDOs.

If, at block 804, k is less than the number of SourceCapabilities PDOs/APDOs (Y), then, at block 808, supply type of PDO[k] is checked against the fixed supply type, where PDO[k] refers to the kth SourceCapabilities PDO/APDO. If, at block 804, supply type of PDO[k] is fixed supply type (Y), then, at block 810, a voltage-related variable V_PDO is assigned with voltage level of PDO[k] which is already initialized in the INIT_DISCOVERY_PWR_PROTOCOL subroutine or ADV_CHG_VBUS_PWR subroutine before calling the POPULATE_SOURCE_CAP_PDOs subroutine. Else if, at block 804, supply type of PDO[k] is not fixed supply (N), then, at block 818, supply type of PDO[k] is checked against variable supply type. If supply type of PDO[k] is variable supply type (Y), then, at block 820, V_PDO is assigned with maximum voltage level of PDO[k]. Else if, at block 818, supply type of PDO[k] is neither fixed supply nor variable supply (N), then, at block 824, assuming PDO[k] is of supply type PPS, power limit bit of the PPS PDO is assigned to 1 if constant power mode is supported, else assigned to 0 if constant power mode is not supported. At block 826, the second set of instructions check whether constant power mode is supported. If constant power mode is supported (Y), then, at block 828, V_PDO is assigned with nominal voltage level of PDO[k]. Else if, at block 826, constant power mode is not supported, then, at block 820, V_PDO is assigned with maximum voltage level of PDO[k].

At block 812, maximum current value for the PDO[k] is updated based on V_PDO voltage (assigned at block 810/820/828) and power allocated to the port by the first set of instructions, i.e., P_ALLOC. Maximum current value for PDO[k] is equal to (P_ALLOC)/(V_PDO). At block 814, k is incremented by 1 to and the loop re-runs at block 804 to check whether k is less than the number of SourceCapabilities PDOs/APDOs.

If, at block 804, k is not less than the number of SourceCapabilities PDOs/APDOs, the subroutine finishes, implying the VBUS current related fields in all SourceCapabilities PDOs/APDOs are populated.

FIG. 9 illustrates an exemplary representation of a CHK_SNK_REQ subroutine of the SHA to validate power request from a sink device, in case USB PD is active on the port, in accordance with an embodiment of the present disclosure. The subroutine CHK_SNK_REQ returns three response, the first response being a VALID status response indicating the validity of the sink request, the second response being an SRNM status response which, when set to 1, indicates insufficiency of power allocated for the connected sink and the third response being the minimum current value, IMIN, if advertised by the connected sink.

At block 902, a variable k is assigned to the PDO/APDO object position requested by the sink, as part of USB PD Request message, which is sent by sink in response to the SourceCapabilities message transmitted by the second set of instructions to the sink. At block 904, k is checked to have a valid value as per the number of SourceCapabilities PDOs/APDOs. k is valid if it is non-zero and if it is not greater than the total number of SourceCapabilities PDOs/APDOs. If, at block 904, k is found to be invalid (N), then, at block 928, the VALID response is set to 0 and the SRNM response is set to 0, and, at block 930, Reject message is sent as further response to the sink. If, at block 904, k is valid (Y), then, at block 906, the second set of instructions check whether the requested current IREQ, as part of Request message, is less than the maximum current advertised in SourceCapabilities PDO[k], referred to as I_PDO[k]. If IREQ is greater than I_PDO[k] (N), then, at block 928, the VALID response is set to 0 and the SRNM response is set to 0, and, at block 930, Reject message is sent as further response to the sink. Else if, at block 906, IREQ is less than or equal to I_PDO[k] (Y), then, at block 908, the VALID response is set to 1.

At block 910, the second set of instructions check whether the requested supply type in the Request message is Fixed supply. If the supply type is not Fixed supply (N), then, at block 924, the second set of instructions check whether the requested voltage, as part of Request message, VREQ, is within the minimum and maximum voltage values advertised in the Variable/PPS supply PDO[k]. If VREQ is not within the minimum and maximum voltage values of PDO[k] (N), then, at block 928, the VALID response is set to 0 and the SRNM response is set to 0, and, at block 930, Reject message is sent as further response to the sink. Else if, at block 924, VREQ is within the minimum and maximum voltage values of PDO[k](Y), then, at block 926, a voltage VMAX is assigned to the highest Variable/PPS supply PDO/APDO maximum voltage value. If, at block 910, the supply type is Fixed supply (Y), then, at block 912, VMAX is assigned to the highest Fixed supply PDO voltage value.

At block 914, the second set of instructions check whether the allocated power, P_ALLOC, is greater than or equal to the product of VMAX and I_CABLE, where I_CABLE is the maximum VBUS current supported by the cable connected to the port. If P_ALLOC is greater than or equal to VMAX×I_CABLE (Y), then, at block 916, the SRNM response is assigned the same value as the CapabilityMismatch bit in the Request message RDO. Else if, at block 914, P_ALLOC is less than VMAX×I_CABLE (N), then, at block 922, the SRNM response is set to 0. At block 918, Accept message is sent as further response to the sink.

At block 932, the second set of instructions check whether GiveBack bit is set to 1 in the Request message RDO. If GiveBack bit is set to 1 (Y), then, at block 936, the IMIN response is set to the minimum current value as decoded from the Request message RDO. Else if, at block 932, if GiveBack bit is set to 0 (N), then, at block 934, IMIN response is set to a dummy value same as operating current in the Request message RDO, IREQ, indicating that the minimum operating current of the sink is same as the operating current of the sink.

FIG. 10 illustrates an exemplary representation of a TRANS_VBUS subroutine of the SHA, in case USB PD is active on the port, in accordance with an embodiment of the present disclosure. The TRANS_VBUS subroutine returns the negotiated power level, P_NEG, as response.

At block 1002, the second set of instructions check whether the supply type according to the object position given by the sink in Request message is Fixed or Variable supply. If the supply type is Fixed or Variable supply (Y), then, at block 1004, the current limit is updated with IREQ value, and at block 1008, VBUS voltage is transitioned to voltage level according to the requested object position, and at block 1012, P_NEG is updated as P_NEG=VREQ×IREQ. At block 1016, PS_RDY message is sent to the sink. If, at block 1002, the supply type is neither Fixed not Variable supply (N), then, assuming PPS supply type, at block 1006, current limit is set to IREQ, and at block 1010, VBUS voltage is transitioned to VREQ according to the Request message or an appropriate voltage level according to PPS region of operation which depends on the amount of load present. At block 1014, P_NEG is updated as P_NEG=P_ALLOC and, at block 1016, PS_RDY message is sent to the sink.

FIG. 11 illustrates an exemplary representation of SNK_PROF_DET subroutine of the SHA, in case USB PD is active on the port, in accordance with an embodiment of the present disclosure. The SNK_PROF_DET subroutine performs discovery/detection of sink power profiles for USB PD sinks, and returns the power profile discovered, P_REQ, to the MCA. The power profile discovered response, P_REQ, consists of two power values, first being P_NEXT indicating the next higher power required by the sink, and the second being P_MAX indicating the highest power required by the sink.

At block 1102, the USB PD GetSinkCapabilities message is sent to the sink to retrieve the sink power profiles, whenever requested by the first set of instructions. At block 1104, the second set of instructions check whether SinkCapabilities response message is received. If the SinkCapabilities response message is received (Y), then, at block 1106, the SinkCapabilities PDOs/APDOs are stored in the memory for further usage. At block 1108, P_NEXT response is initialized to the highest power level supported by USB PD specification, P_MAX response is initialized to the allocated power for the port, P_ALLOC, and a loop variable k, to iterate over SinkCapabilities PDOs/APDOs, is initialized to 0.

At block 1110, the second set of instructions check whether k is less than the number of SinkCapabilities PDOs/APDOs. If k is less than the number of SinkCapabilities PDOs/APDOs (Y), then, at block 1112, the supply type of PDO[k] checked against Fixed supply type, where PDO[k] refers to the kth SinkCapabilities PDO/APDO. If PDO[k] is of Fixed supply type (Y), then, at block 1114, the voltage VPDO is assigned as the voltage value in PDO[k], the current IPDO is assigned as minimum of the three of operating current in PDO[k], I_CABLE and I_RATING, where I_CABLE is the maximum VBUS current supported by the cable and I_RATING is the VBUS current rating of the power supply. Further, at block 1114, PPDO is assigned as VPDO×IPDO. If, at block 1112, the supply type of PDO[k] is not Fixed supply (N), then, at block 1128, the second set of instructions check whether the supply type of PDO[k] is Variable supply. If PDO[k] is of Variable supply type (Y), then, at block 1130, the voltage VPDO is assigned as the maximum voltage value in PDO[k], the current IPDO is assigned as minimum of the three of operating current in PDO[k], I_CABLE and I_RATING. Further, at block 1130, PPDO is assigned as VPDO×IPDO. If, at block 1128, the supply type of PDO[k] is not Variable supply (N), then, assuming PPS supply type, at block 1132, the voltage VPDO is assigned as the maximum voltage value in PDO[k], the current IPDO is assigned as minimum of the three of operating current in PDO[k], I_CABLE and I_RATING. Further, at block 1132, PPDO is assigned as VPDO×IPDO.

After computing PPDO in block 1114/1130/1132, at block 1116, the second set of instructions check whether PPDO is greater than the allocated power for the port, P_ALLOC, and PPDO is less than or equal to the P_NEXT higher sink power requirement. If PPDO is greater than the allocated power for the port, P_ALLOC, and PPDO is less than or equal to the P_NEXT higher sink power requirement (Y), then, at block 1118, the P_NEXT higher sink power requirement is set to PPDO, and at block 1120, P_MAX maximum sink power requirement is set to the maximum of the two of present value of P_MAX and PPDO. If, at block 1116, PPDO is less than or equal to P_ALLOC, or PPDO is greater than the P_NEXT higher sink power requirement (N), then, at block 1120, P_MAX maximum sink power requirement is set to the maximum of the two of present value of P_MAX and PPDO.

At block 1122, k is increment by 1 and the loop is re-run at block 1110, to check whether k is less than the number of SinkCapabilities PDOs/APDOs. If, at block 1110, k is greater than or equal to the number of SinkCapabilities PDOs/APDOs, then, at block 1124, the P_REQ response indicating sink power profile, consisting of P_NEXT and P_MAX is returned.

FIG. 12 is a high-level flow diagram illustrating steps for distribution of power in a multiport power sourcing device in accordance with an embodiment of the present disclosure.

In an embodiment, a method is provided for facilitating dynamic power allocation and distribution in a multi-port power sourcing device. The method facilitates to block 1202 receive by a first set of instructions to be executed on a multi-port power sourcing device receiving, by a first set of instructions to be executed on a multi-port power sourcing device, one or more input parameters at the multi-port power sourcing device, the one or more input parameters pertaining to a plurality of ports of the device, total power rating of the device, maximum power rating of each of a port of the plurality of ports and minimum guaranteed power to be reserved for each of the port of the plurality of ports.

At block 1204, execute at the multi-port power sourcing device the first set of instructions based on the input parameters, the first set of instructions pertaining to power distribution and operational decision-making across each of the port of the plurality of ports of the multi-port power sourcing device, wherein the executed first set of instructions have one instance for the multi-port power sourcing device and manage allocated power across each of the port of the plurality of ports and available power.

Further, at block 1206, execute at the multi-port power sourcing device a second set of instructions based on the executed first set of instructions. The second set of instructions being executed to manage operations pertaining to a single port of the plurality of ports of the multi-port power sourcing device, wherein the executed first set of instructions control the second set of instructions via a request-response communication interface.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The present disclosure provides a method that facilitates to distribute power dynamically for multiport power sourcing devices.

The present disclosure provides a method that facilitates to distribute power in a USB Type-C/Type-A based multiport power sourcing device.

The present disclosure provides a method that facilitates to distribute power for multiport power sourcing devices while complying to base rules specified by USB Type-C, USB Type-A, USB power delivery specifications and other charging protocols.

The present disclosure provides a method that facilitates to encompasses both shared capacity and assured capacity power adapters as per USB Type-C specification and specifies additional power sharing configurations.

The present disclosure provides a method that facilitates to handle detection of a device connection/disconnection, dynamic power allotment and redistribution through a sink profile detection/discovery and communication.

The present disclosure provides a method that facilitates to handle USB PD source capabilities dynamic generation focused on sink capabilities.

The present disclosure provides a method that facilitates to handle sink notifications for insufficient power and performing possible power redistribution.

I/We claim:

1. A method for facilitating dynamic power allocation and distribution in a multi-port power sourcing device, said method comprising:
receiving, by a first set of instructions to be executed on a multi-port power sourcing device, one or more input parameters at the multi-port power sourcing device, the one or more input parameters pertaining to a plurality of ports of the device, total power rating of the device, maximum power rating of each of a port of the plurality of ports and minimum guaranteed power to be reserved for each of the port of the plurality of ports;
executing, at the multi-port power sourcing device the first set of instructions based on the one or more input parameters, the first set of instructions pertaining to power distribution and operational decision-making across each of the port of the plurality of ports of the multi-port power sourcing device, wherein the executed first set of instructions have one instance for the multi-port power sourcing device and manage allocated power across each of the port of the plurality of ports and available power; and
executing, at the multi-port power sourcing device a second set of instructions based on the executed first set of instructions, the second set of instructions being executed to manage operations pertaining to a single port of the plurality of ports of the multi-port power sourcing device, wherein the executed first set of instructions control the second set of instructions via a request-response communication interface.

2. The method as claimed in claim 1, wherein each of the port of the plurality of ports of the multi-port power sourcing device is any of a Universal Serial Bus (USB) Type-C port and a USB Type-A port, and where each of the plurality of ports comply to a predefined USB power delivery specification or to a predefined proprietary charging protocol.

3. The method as claimed in claim 1, wherein upon execution of the second set of instructions power is delivered to the single port over a VBUS line of a physical USB port based on an active power negotiation protocol and on control requests received from the first set of instructions.

4. The method as claimed in claim 1, wherein the first set of instructions is configured to perform power distribution across each of the port of the plurality of ports of the multi-port power sourcing device using at least one of an Individual-Dedicated-Reserve (IDR) power distribution mechanism, a Common-Combined-Reserve (CCR) power distribution mechanism or a Hybrid-Reserve (HR) power distribution mechanism.

5. The method as claimed in claim 4, wherein when the power distribution is performed using the IDR power distribution mechanism, a power rating sum of individual ports of the plurality of ports is equal to a total power rating of the multi-port power sourcing device, wherein each of the port of the plurality of ports is allocated a dedicated power rating, and wherein the second set of instructions manage a dedicated power reserve with or without communicating with the first set of instructions.

6. The method as claimed in claim 4, wherein when the power distribution is performed using the CCR power distribution mechanism, a power rating sum of individual ports of the plurality of ports is greater than a total power rating of the multi-port power-sourcing device and the first set of instructions allocate power from a specified common power reserve such that power allocation to a port is upgraded in incremental steps based on sink power requirements.

7. The method as claimed in claim 6, wherein the first set of instructions are executed to perform power distribution across the plurality of ports using any of the IDR power distribution mechanism or the CCR power distribution mechanism, and wherein the first set of instructions controls the power allocation to each of the port such that the allocated power neither exceeds an individual power rating of the each of the port nor the total power rating of the multi-port power-sourcing device.

8. The method as claimed in claim 4, wherein when the multi-port power sourcing device is switched on and the device uses the CCR power distribution mechanism, the first set of instructions executed on the multi-port power sourcing device activates each of the second set of instructions associated with each of the ports, and wherein the first set of instructions are configured to inform each of the second set of instructions about a minimum level of power to be reserved and allocated on each of unconnected port of the plurality of ports.

9. The method as claimed in claim 8, wherein the reserved minimum level of power to be allocated is configurable, and is allocated dynamically on a USB Type-C connection configuration channel (CC) line detection, and wherein the second set of instructions are executed to supply the minimum allocated power over VBUS at a sink connection detection event when the initial allocated power is greater than or equal to 7.5 W for Type-A connection and 15 W for Type-C connection.

10. The method as claimed in claim 9, wherein in case the minimum allocated power for a port with a new USB Type-C sink connection is less than 15 W due to power unavailability, the second set of instructions are executed to wait for a power allocation of greater than or equal to 15 W from the first set of instructions to start supplying VBUS power, and wherein the first set of instructions during the wait time deallocates the required amount of power from the plurality of ports in a balanced or priority manner.

11. The method as claimed in claim 10, wherein, in case the minimum allocated power for a port with a new USB Type-C sink connection is less than 15 W due to power unavailability, for a USB-PD protocol, the first set of instructions immediately force a give back capable sink connected to any of the other ports by instructing the second set of instructions to send a GotoMin message to retrieve the give back power and provide the initial minimum power required for the new sink connection, wherein the second set of instructions decode the give back power, if advertised in the request message sent by a sink connected to any of the other ports, and inform the first set of instructions.

12. The method as claimed in claim 6, wherein when the power distribution is performed using the CCR power distribution mechanism, the second set of instructions, after detecting a sink device connection, discover support of a higher power negotiation protocol and upon discovering the support, the second set of instructions advertise different voltage profiles and corresponding current limits adhering to the power allocated to the port by the first set of instructions, and where the different voltage profiles are custom configured or are based on a set of profiles dependent on the higher power negotiation protocol.

13. The method as claimed in claim 12, wherein for an upgrade in the higher power negotiation protocol, the second set of instructions are executed to discover a sink support of the USB Power Delivery (USB-PD) protocol by sending a first data packet on a CC line and awaiting a time bounded detection of the second data packet from a sink across a set number of retry attempts, and wherein the second set of instructions uses the first data packet to advertise custom-configured or normative power profiles that are configured based on supply type and supply voltage, and wherein the current limits advertised corresponding to each power profile are dynamically set by the second set of instructions to adhere to the power allocated to the port by the first set of instructions.

14. The method as claimed in claim 13, wherein for an upgrade in the higher power negotiation protocol, the second set of instructions are executed to discover sufficiency of an allocated power according to an established power negotiation protocol and an alert signal is sent to the first set of instructions related to success or failure of establishment of the higher power negotiation protocol, wherein the alert signal further comprises information related to sufficiency of allocated power to meet sink power requirements.

15. The method as claimed in claim 6, wherein the first set of instructions are executed to instruct the second set of instructions to discover or detect higher sink power requirements, and where the second set of instructions inform about the discovered or detected higher sink power requirements to the first set of instructions by following a sink profile discovery mechanism, and where the first set of instructions are executed to upgrade the power allocated to the single port, in a conservative manner, to minimum of three of power detected or power discovered by the second set of instructions, available power in the common power reserve, and the port power rating.

16. The method as claimed in claim 15, where the sink profile discovery or detection is done by the second set of instructions only once initially until disconnection of the sink device, and wherein the discovered sink profiles are preserved by the second set of instructions, and are requested by the first set of instructions when needed.

17. The method as claimed in claim 15, where in another configuration, the first set of instructions are executed to periodically request the second set of instructions to discover and detect the sink profiles.

18. The method as claimed in claim 15, where the first set of instructions are additionally executed to request the second set of instructions to discover and detect the sink profiles whenever a power allocation change happens to any of the other port of the plurality of ports.

19. The method as claimed in claim 15, wherein the power allocated to the single port is configurable, and the power is allocated in a no-priority balanced manner, or priority-based manner to the single port, where the priority based manner is based on any of a random order, a round-robin order, a connection order, and an increasing order of the allocated power.

20. The method as claimed in claim 4, wherein one or more port groupings are provided for the IDR power distribution mechanism or the CCR power distribution mechanism, and wherein each of the port of the plurality of ports has the individual power rating that is either similar or is varying within a port grouping of the one or more port groupings.

21. The method as claimed in claim 20, wherein for the CCR power distribution mechanism, a maximum individual port power rating for a port is equal to the total power rating of the multi-port power sourcing device.

22. The method as claimed in claim 4, wherein for performing a power upgrade in the CCR power distribution mechanism, the second set of instructions inform the first set of instructions of a next higher power and a highest power required by the sink, wherein the first set of instructions perform multiple rounds of retrievals of next higher power and corresponding allocated power upgrades, wherein the first set of instructions directly upgrade the allocated power to the highest power level required by the sink, if the power is available and if configured to do so, either after a maximum configurable rounds of allocated power upgrades or after a particular timeout from the time of sink connection detection.

23. The method as claimed in claim 22, wherein for the USB-PD protocol the second set of instructions decode the next higher power by comparing an operational current value from a third data packet with a maximum current supported by the USB Type-C cable, and wherein a lesser value of the operational current value and the maximum cable current is used to determine a power requirement, the determined power requirement being informed about to the first set of instructions.

24. The method as claimed in claim 8, wherein for the USB-PD protocol, the voltage levels and the supply types mentioned by sink in the third data packet are used by the second set of instructions directly in advertising the next set of capabilities in the first data packet, wherein the maximum current offered for each voltage profile is tuned as per the power allocated to the port by the first set of instructions.

25. The method as claimed in claim 24, wherein for the USB-PD protocol, for a fixed supply sink requirement, the second set of instructions advertise a fixed supply PDO and divide the power allocated to the port by the fixed supply voltage level to facilitate generation of a value of the maximum current field in the first data packet fixed supply PDO.

26. The method as claimed in claim 24, wherein for the USB-PD protocol, the first data packet is generated upon execution of the second set of instructions, wherein for a programmable power supply (PPS) sink requirement, if the second set of instructions is configured to operate in a constant power mode apart from a constant voltage and constant current modes, the second set of instructions advertise a PPS augmented power data object (APDO) and divide the power allocated to the port by a nominal voltage corresponding to maximum and minimum voltage, to facilitate generation of value of maximum current field in the first data packet PPS supply APDO, and the second set of instructions sets the power limited to ‘1’ in the first data packet PPS supply APDO.

27. The method as claimed in claim 26, wherein if the second set of instructions is configured to not support a constant power mode, the second set of instructions divide the power allocated to the port by a maximum voltage level to generate a value of a maximum current field in the first data packet PPS supply APDO, wherein the second set of instructions set power limited to ‘0’ during the first data packet PPS supply APDO.

28. The method as claimed in claim 24, wherein for the USB-PD protocol, for a variable supply sink requirement, the second set of instructions advertise a variable supply PDO, wherein the maximum and minimum voltage in the variable supply PDO are set based on the regulation range of the power supply, and wherein the power allocated to the port is divided by the maximum voltage level to facilitate generation of the value of the maximum current field in the first data packet variable supply PDO.

29. The method as claimed in claim 24, wherein for the USB-PD protocol, for all supply types, the maximum current value generated by the second set of instructions is limited to the maximum current supported by the cable.

30. The method as claimed in claim 8, wherein the first set of instructions maintain a first flag for each of the port of the plurality of ports, wherein the first flag set to 1 for a port is an indication of insufficient power allocated to the port, and wherein for the USB-PD protocol, the first flag value is deduced by the second set of instructions directly or indirectly from a CapabilityMismatch bit in a Request Data Object (RDO) of the Request message sent by the sink.

31. The method as claimed in claim 30, wherein the first flag for a port is cleared by the first set of instructions on occurrence of any of an event related to a power upgrade by the first set of instructions to meet the power requirements of the sink on the port, reduction of sink power requirement informed by the sink or detected by the second set of instructions on the port, and a sink disconnection event on the port.

32. The method as claimed in claim 30, wherein, for the USB-PD protocol, the first set of instructions clear the first flag value associated with a port in case when the sink sends a Request message with CapabilityMismatch bit cleared, either with or without any allocated power upgrade done by the first set of instructions.

33. The method as claimed in claim 30, wherein, the first set of instructions clear the first flag value associated with a port when the power allocation to the port cannot be upgraded by the first set of instructions as the already allocated power is equal to the power rating of the port.

34. The method as claimed in claim 30, wherein the first set of instructions mask the first flag value associated with a port on occurrence of at least no possible power upgrade due to zero available power or the current requirement of the sink exceeding the current rating of the port or the current rating of the cable.

35. The method as claimed in claim 30, wherein the first set of instructions unmask the first flag values for all the ports on a new power allocation to or a sink disconnection on any of the ports of the plurality of ports.

36. The method as claimed in claim 6, wherein the first set of instructions reduce allocated power to a port in case the sink connected reduces its power requirements or the sink gets disconnected, and wherein the reduced allocated power is dynamically allocated to the other needy ports, based on either a balanced or a priority mechanism, wherein the reduction of allocated power requirement of the sink may be notified by the sink itself or is detected and discovered by the second set of instructions.

37. The method as claimed in claim 36, wherein when the power distribution is performed using a HR power distribution mechanism, the first set of instructions are executed to perform the power distribution across the plurality of ports using any of the IDR mechanism or the CCR power distribution mechanism.

38. The method as claimed in claim 37, wherein, for the HR power distribution, the first set of instructions manage either separate dedicated power reserves across the IDR and CCR groups of ports, or a total power reserve across the IDR and CCR groups of ports, wherein, for the total power reserve, the power on CCR groups of ports is allocated as per total power rating of the multi-port power sourcing device, as long as all of the IDR ports remain unconnected, and wherein, upon an IDR port getting connected, power equal to the rating of the IDR port is allocated by the first set of instructions to the port from an available power reserve, else the allocated power on the connected CCR port is reduced in a balanced manner or a priority-based order.
